(19) United States
(12) Patent Application Publication
(10) Pub. No.: US 2025/0050352 A1
(43) Pub. Date: Feb. 13, 2025

(54) HETEROGENEOUS MATERIAL PROCESSING SYSTEM AND METHOD

(71) Applicant: Disa Technologies, Inc., Mills, WY (US)

(72) Inventors: Andrew George Pfleider Halverson, Casper, WY (US); John Hamilton Lee, Casper, WY (US); Jordan Dean Dick, Casper, WY (US); Greyson Phillip Buckingham, Casper, WY (US); Garrett Luke Pierpoint, Casper, WY (US)

(21) Appl. No.: 18/801,195

(22) Filed: Aug. 12, 2024

Related U.S. Application Data
(60) Provisional application No. 63/519,166, filed on Aug. 11, 2023.
(60) Provisional application No. 63/590,955, filed on Oct. 17, 2023.

(51) Int. Cl. B03B 9/00; B02C 19/00; C02F 11/121; C22B 60/02

(52) U.S. Cl. CPC B03B 9/00; C02F 11/121; B02C 19/005; C22B 60/0252

(57) ABSTRACT

A system for processing a heterogenous material, the system comprising: a vessel in communication with a primary screen; a first collision chamber in communication with the vessel; a first recovery vessel; a second collision chamber in communication with the first collision chamber; a second recovery vessel; and a secondary screen. A method for processing a heterogenous material, the method comprising: disposing the heterogenous material in a vessel; clarifying the heterogenous material in a clarifier; ablating the heterogenous material in a first collision chamber to form ablated heterogenous material; disposing the ablated heterogenous material in a first recovery vessel; further ablating the ablated heterogenous material from the first recovery vessel to a second collision chamber; and flowing the further ablated heterogenous material in a second recovery vessel.

### CROSS-REFERENCE TO RELATED APPLICATIONS

This application claims priority to and the benefit of the filing of U.S. Provisional Patent Application No. 63/519,166, entitled “HETEROGENEOUS MATERIAL PROCESSING SYSTEM AND METHOD”, filed on Aug. 11, 2023, and the specification and claims thereof are incorporated herein by reference. This application also claims priority to and the benefit of the filing of U.S. Provisional Patent Application No. 63/590,955, entitled “HETEROGENEOUS MATERIAL PROCESSING SYSTEM AND METHOD”, filed on Oct. 17, 2023, and the specification and claims thereof are incorporated herein by reference.

### BACKGROUND OF THE INVENTION

### Field of the Invention (Technical Field)

The present invention relates to a system and method for processing heterogeneous material, in particular, a machine for dissociation of the subfractions of heterogenous materials.

### Related Art

Heterogeneous materials, such as heterogeneous solid materials, occur naturally and may also be formed by man-made processes. For example, naturally occurring ores may include volumes containing a material of interest (i.e., a so-called “bearing fraction”), such as a metal or a mineral, mixed with volumes not containing the material of interest (i.e., a so-called “non-bearing fraction”). Recovery of the material of interest generally requires physical or chemical separation of the bearing fraction from the non-bearing fraction. Chemical separation may require reagents (e.g., cyanide, acids, carbonates), which may be expensive or raise environmental challenges.

As one example of a material of interest, uranium is typically found in nature as uranium ore, e.g., the heterogeneous material. Low-grade uranium ore may contain any form of uranium-containing compounds in concentrations up to about five pounds of U₃O₈ equivalent per ton of ore, whereas higher grade ore may contain uranium-containing compounds in concentrations of about eight pounds of U₃O₈ equivalent per ton of ore or more.

Heterogeneous material deposits may be formed in sandstone by erosion and redeposition. For example, an uplift may raise a mineral-bearing source rock and expose the source rock to the atmosphere. The source rock may then erode, forming solutions of primary and secondary materials of interest. The solutions may migrate along the surface of the earth or through permeable subsurface channels into a sandstone formation, stopping at a structural or chemical boundary. The material of interest may then be deposited as a patina or coating around or between grains of the formation. The material of interest may also be present in carbonaceous materials within sandstone. Minerals may be all or a portion of the cementing material between grains of the formation.

A material of interest may conventionally be recovered through in-situ recovery (ISR), also known in the art as in-situ leaching (ISL) or solution mining. In ISR, a leachate or lixiviant solution is pumped into an ore formation through a well. The solution permeates the formation and dissolves a portion of the ore. The solution is extracted through another well and processed to recover the mineral. Reagents used to dissolve the material of interest disposed in the ore may include an acid or carbonate. ISR may have various environmental and operational concerns, such as mobilization of mineral or heavy metals into aquifers, footprint of surface operations, interconnection of wells, etc. ISR typically requires particular reagents, which must be supplied, recovered, and treated. Because ISR relies on the subsurface transport of a solution, ISR cannot generally be used in formations that are impermeable or shallow.

A material of interest may also conventionally be mined in underground mines or surface mines (e.g., strip mines, open-pit mines, etc.). During such mining activities, it may be necessary to process large quantities of heterogeneous material comprising a material of interest at a concentration too low for economic recovery by conventional processes. Such material (e.g., overburden) may be treated as waste or as a material for use in mine reclamation. Conventional mining may produce significant amounts of such low-concentration material, which may require treatment during or subsequent to mining operations. What is needed is a system and method able to recover a material of interest by reducing the amount of overburden produced by the recovery process.

### BRIEF SUMMARY OF THE INVENTION

Embodiments of the present invention relate to a system for processing a heterogenous material, the system comprising: a vessel in communication with a primary screen; a first collision chamber in communication with the vessel; a first recovery vessel; a second collision chamber in communication with the first collision chamber; a second recovery vessel; and a secondary screen. In another embodiment, the system further comprises a clarifier in communication with said primary screen. In another embodiment, the system further comprises a clarifier in communication with the secondary screen. In another embodiment, the system further comprises a mixing vessel in communication with the primary screen.

In another embodiment, at least one of the collision chambers comprises a nozzle. In another embodiment, at least one of the collision chambers comprises a nozzle spacer system. In another embodiment, at least one of the collision chambers comprises a plurality of nozzles disposed at oblique angles to one another. In another embodiment, the system further comprises a dewatering filter. In another embodiment, at least one of the collision chambers comprises a collision array.

Embodiments of the present invention also relate to a method for processing a heterogenous material, the method comprising: disposing the heterogenous material in a vessel; clarifying the heterogenous material in a clarifier; ablating the heterogenous material in a first collision chamber to form ablated heterogenous material; disposing the ablated heterogenous material in a first recovery vessel; further ablating the ablated heterogenous material from the first recovery vessel to a second collision chamber; and flowing the further ablated heterogenous material in a second recovery vessel. In another embodiment, the method further comprises mixing the heterogenous material. In another embodiment, the method further comprises screening the heterogenous material. In another embodiment, the method further comprises splitting the heterogenous material with a splitter. In another embodiment, the method further comprises ablating the heterogenous material with a collision array. In another embodiment, the method further comprises ablating the heterogenous material with a combined chamber array.

In another embodiment, the method further comprises separating the ablated heterogenous material with a flow dividing chute. In another embodiment, the method further comprises screening the ablated heterogenous material. In another embodiment, the method further comprises contacting the ablated heterogenous material with a reagent. In another embodiment, the reagent comprises a frother. In another embodiment, the method further comprises collecting the ablated heterogenous material in a collection tank.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a flow-chart showing a heterogeneous material processing method according to an embodiment of the present invention;

FIG. 2 is an illustration showing a cut-away view of the nozzle installed in the nozzle chamber with the nozzle spacers additionally installed according to an embodiment of the present invention;

FIG. 3 is an illustration showing a perspective view of a pair of nozzles with nozzle spacers according to the present invention;

FIG. 4 is an illustration showing a perspective view of a collision chamber with nozzles installed and without nozzle spacers installed according to an embodiment of the present invention;

FIGS. 5A, 5B, 5C, 5D and 5E are a series of illustrations showing perspective views of skid components of a system according to an embodiment of the present invention;

FIG. 6 is an illustration showing components and processing steps for a system according to an embodiment of the present invention;

FIG. 7 is a photograph showing a top perspective view of a recovery tank with a mechanical agitator according to an embodiment of the present invention;

FIG. 8 is a photograph showing a top perspective view of a mixing tank with a mechanical agitator according to an embodiment of the present invention;

FIG. 9 is a photograph showing a top perspective view of an ore conveyor and mixing tank according to an embodiment of the present invention;

FIG. 10 is a photograph showing a side view of a pump's impeller orientation and stream splitter according to an embodiment of the present invention;

FIG. 11 is a photograph showing a side view of splitter and flow adjustment valves according to an embodiment of the present invention;

FIG. 12 is a table showing the mass balance for a system according to an embodiment of the present invention;

FIG. 13 is a table showing the mass balance for a system according to an embodiment of the present invention;

FIG. 14 is an illustration showing a side view of a collision chamber with nozzles installed and with nozzle spacers according to an embodiment of the present invention;

FIG. 15 is an illustration showing an exploded view of a nozzle and nozzle spacer according to an embodiment of the present invention;

FIG. 16 is a schematic diagram showing a system for processing heterogeneous material comprising an individual chamber (“IC”) collision array, according to an embodiment of the present invention;

FIG. 17 is a schematic diagram showing a system for processing heterogeneous material comprising a plurality of recirculation collision pumps, according to an embodiment of the present invention;

FIG. 18 is a schematic diagram showing a system for processing heterogeneous material comprising a system inlet tank, according to an embodiment of the present invention;

FIG. 19 is a schematic diagram showing a system for processing heterogeneous material comprising a combined chamber array (“CCA”), according to an embodiment of the present invention;

FIG. 20 is a schematic diagram showing a system for processing heterogeneous material comprising an inter-collision separation device, according to an embodiment of the present invention;

FIGS. 21A and 21B are illustrations showing collision chambers comprising angled adapters, according to an embodiment of the present invention, FIG. 21A showing a top down view and FIG. 21B showing a side view;

FIG. 22 is a schematic diagram showing a system for processing heterogeneous material comprising a plurality of catch tanks, according to an embodiment of the present invention;

FIG. 23 is a schematic diagram showing a system for processing heterogeneous material comprising a flow dividing chute, according to an embodiment of the present invention;

FIG. 24 is a schematic diagram showing a system for processing heterogeneous material comprising a splitter simultaneously directing heterogeneous material into a system inlet tank and catch tank, according to an embodiment of the present invention;

FIG. 25 is a schematic diagram showing a system for processing heterogeneous material comprising an overflow launder and a collection tank, according to an embodiment of the present invention;

FIG. 26 is photographs showing quartz grain disposed with uranium pre-high-pressure slurry ablation (“HPSA”) and post-HPSA;

FIG. 27 is a graphic illustration of selective liberation of material of interest from heterogenous material by HPSA;

FIG. 28 is a table showing a summary of heterogenous material treated with HPSA according to an embodiment of the present invention;

FIG. 29 is a table showing a summary of heterogenous material treated with HPSA according to an embodiment of the present invention;

FIG. 30 is a table showing a summary of heterogenous material treated with HPSA according to an embodiment of the present invention;

FIG. 31 is a schematic diagram showing an ablation loop, according to an embodiment of the present invention;

FIGS. 32A, 32B, and 32C are schematic diagrams showing the side view, front view, and isometric view of a radial collision chamber array, according to an embodiment of the present invention; and

FIGS. 33A, 33B, and 33C are schematic diagrams showing the side view, front view, and isometric view of a linear collision chamber array, according to an embodiment of the present invention.

### DETAILED DESCRIPTION OF THE INVENTION

The system and method of the present invention may be used to ablate an ore and/or mineral, including but not limited to, sandstone, silicates, claystone, siltstone, mudrock, limestone, other sedimentary rock, metal sulfide, metal oxide, or a combination thereof; or for the recovery of a selected material of interest including, but not limited to, a metal-containing compound. The material of interest may be a post-depositional material, carried into an already established sandstone formation by mineral-bearing solutions. Without being bound to any particular theory, it is believed that when these mineral-bearing solutions reached a reduction zone, carbon caused the uranium to reduce and precipitate out of solution to form stable uranium-containing compounds. Metal-containing compounds may form as a mineral patina surrounding grains and/or in carbonaceous material. The system and method of the present invention may ablate a heterogeneous material at a greater rate, at greater efficiency, or at a lower cost than conventional ablation systems and methods. The system and method of the present invention may also ablate more types of heterogeneous material than conventional ablation systems and methods.

Embodiment of the present invention relate to a system and method for the processing of heterogeneous material. In particular, the system and method of the present invention may ablate heterogeneous material to produce a material of interest.

The system and method of the present invention may be continuously operated. The system may be continuously operated by use of splitting a flow of heterogeneous material into a plurality of collision chambers and/or arrays; a modular tank; froth collection and/or flotation; a modular collision chamber; or a combination thereof.

The system and method may comprise splitting a flow of heterogeneous material from pumps into a plurality of collision chambers and/or collision arrays. The arrays may allow for control of throughput of the system and/or degree of dissociation of the heterogeneous material. For example, use of either the collision array and/or splitter, which may be a collision exit flow splitter, may allow for control of material division between tanks operated in a system for the processing heterogeneous material.

The system and method may comprise a tank that may be modular and/or connectable for different system throughputs or desired product results. The tank may be made modular and/or connectable to different systems using a recirculation and a collision and/or draw-off pump for a single tank.

The system and method may comprise elements for froth collection and/or floatation. Flotation allows for the method to comprise a combined dissociation and separation step to allow one stream to enter a system with two streams exiting the system. The system and method may comprise internal classification elements to separate heterogeneous material based on particle size and/or the surface properties of heterogeneous material dissociated by flotation.

The system and method may comprise a modular collision chamber that allows for heterogeneous stream angles to be changed. The angles may be changed by an adapter and/or plate attached to the collision chamber. The modular collision chamber may be configured to alternate between a chamber comprising more than two streams entering the collision chamber to a chamber with only two streams entering the collision chamber.

The term “heterogeneous material” as used herein includes, but is not limited to, an ore, rock, mineral, mining or industrial waste, agglomerate, slurry, fines, particles, comminuted matter, crushed matter, mineral tailings, sand, oil sand, or a combination thereof. The heterogeneous material may comprise a material of interest and may further comprise a bulk material.

The term “material of interest” as used herein includes, but is not limited to, a metal, including but not limited to a metal ion, metal compound, metal atom, or a combination thereof; a mineral; oil; clay; bitumen; sand; an agricultural product including, but not limited to, rice, seeds, nuts, or a combination thereof; a chemical powder; or a combination thereof.

The term “metal” as used herein includes, but is not limited to, a metal ion, metal compound, or a combination thereof. The metal may include, but is not limited to, neodymium (“Nd”), praseodymium (“Pr”), dysprosium (“Dy), copper (“Cu”), lithium (“Li”), sodium (“Na”), magnesium (“Mg”), potassium (“K”), calcium (“Ca”), titanium (“Ti”), vanadium (“V”), chromium (“Cr”), manganese (“Mn”), iron (“Fe”), cobalt (“Co”), nickel (“Ni”), cadmium (“Cd”), zinc (“Zn”), aluminum (“Al”), silicon (“Si”), silver (“Ag”), tin (“Sn”), platinum (“Pt”), gold (“Au”), bismuth (“Bi”), lanthanum (“La”), europium (“Eu”), gallium (“Ga”), scandium (“Sc”), strontium (“Sr”), yttrium (“Y”), zirconium (“Zr”), niobium (“Nb”), molybdenum (“Mo”), ruthenium (“Ru”), rhodium (“Rh”), palladium (“Pd”), indium (“In”), hafnium (“Hf”), tantalum (“Ta”), tungsten (“W”), rhenium (“Re”), osmium (“Os”), iridium (“Ir”), mercury (“Hg”), lead (“Pb”), polonium (“Po”), cerium (“Ce”), samarium (“Sm”), erbium (“Er”), ytterbium (“Yb”), thorium (“Th”), uranium (“U”), plutonium (“Pu”), terbium (“Tb”), promethium (“Pm”), tellurium (“Te”), or a combination thereof.

The terms “ablate”, “ablation”, or “ablated” as used herein means and includes wearing away by flexure, rebound, and distortion. Ablation may also include, but is not limited to, wear by friction, chipping, spalling, another erosive process, or a combination thereof. Ablation may be used to separate one or more materials of interest in a heterogeneous material. The separation may be achieved based on the physical characteristics of the material of interest. When particles are ablated, the boundary between different materials of interest in a heterogeneous material may become more highly stressed than the bulk materials themselves. Ablation may physically remove coatings from an underlying bulk material or a material of interest. Ablation imparts energy to the heterogeneous material being ablated to physically dissociate the material into various fractions (e.g., a solid fraction and an oil or two solid fractions). The ablated particles may then be classified to divide the heterogenous material into various fractions. Ablation and separation may significantly reduce the amount of material to be further processed to recover the one or more desired components of the heterogeneous material. Heterogeneous material may be repeatedly ablated. Ablated material that is subject to additional ablation is further ablated heterogeneous material.

The term “formation” as used herein means a naturally occurring region of heterogeneous material disposed at or below ground level.

The terms “tank” and “vessel” are used interchangeably throughout and mean any object capable of holding and/or containing matter.

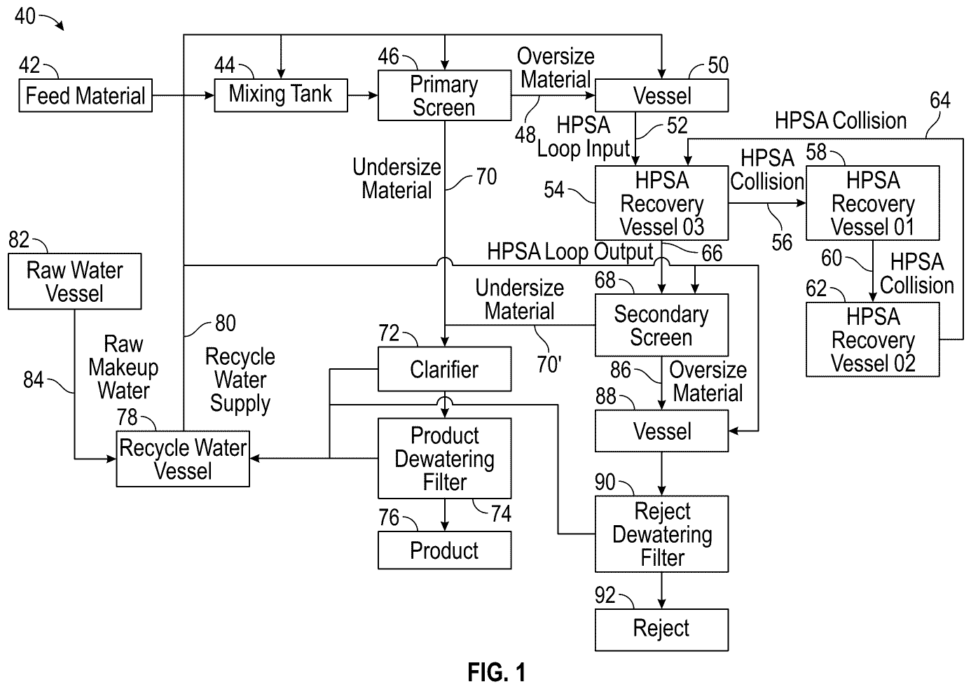

Turning now to the figures, FIG. 1 shows system 40. Feed material 42 (e.g., heterogeneous material) is transferred to mixing tank 44 where it is combined with water and/or an aqueous solution. The mixed heterogeneous material contacts primary screen 46 and is separated into undersized heterogeneous material 70 and oversized heterogeneous material 48. Oversized heterogeneous material 48 is transferred as high-pressure slurry ablation (“HPSA”) loop input 52 into HPSA recovery vessel 03 54. Oversized heterogeneous material 48 then undergoes HPSA collision 56 in a first collision chamber (not shown). The ablated heterogeneous material is transferred to HPSA recovery vessel 01 58 and then undergoes HPSA collision 60 in a second collision chamber (not shown). The ablated heterogeneous material is then transferred to HPSA recovery vessel 02 62 and undergoes HPSA collision 64 in a third collision chamber (not shown) before being returned to HPSA recovery vessel 03 54. Ablated heterogeneous material leaves HPSA recovery vessel 03 54 as HPSA loop output 66 and contacts secondary screen 68. Secondary screen 68 separates ablated heterogeneous material into oversized ablated heterogeneous material 86 and undersized ablated heterogeneous material 70′. Oversized ablated heterogeneous material 86 enters vessel 88 and subsequently contacts reject dewatering filter 90, which separates oversized ablated heterogeneous material 86 into water and waste. Water from reject dewatering filter 90 flows into recycle water vessel 78 and reject 92 is removed from system 40. Undersized heterogeneous material 70 and undersized ablated heterogeneous material 70′ are transferred to clarifier 72. Output from clarifier 72 contacts product dewatering filter 74, which separates clarifier 72 output into water and product 76. Water from product dewatering filter 74 flows into recycle water vessel 78 and product 76 is removed from system 40. Water 80 from recycle water vessel 78 flows into mixing tank 44, primary screen 46, vessel 50, secondary screen 68, and vessel 88. Raw makeup water 84 from raw water vessel 82 flows into recycle water vessel 78 to maintain sufficient fluid flow and fluid levels in system 40. The person skilled in the art understands that the term “water” as used in the description of FIG. 1 includes, but is not limited to, an aqueous solution, water with salts and/or solutes, or a combination thereof.

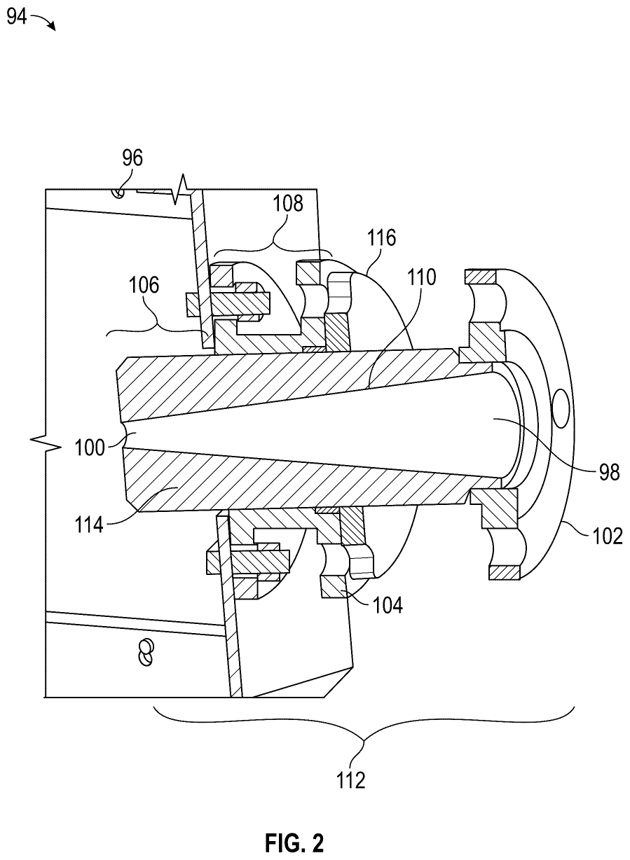

FIG. 2 shows nozzle and nozzle spacer system 94. Nozzle 112 is disposed through housing 96. Nozzle 112 extends through housing 96 by length 106. Nozzle spacer 104 is disposed around base section 114 and between housing 96 and proximal ring 116. Nozzle spacer 104 forms length 108. Distal ring 102 is attached to an end of nozzle 112. Channel 98 is disposed through base section 114 and is narrowed by tapered wall 110 to form channel end 100.

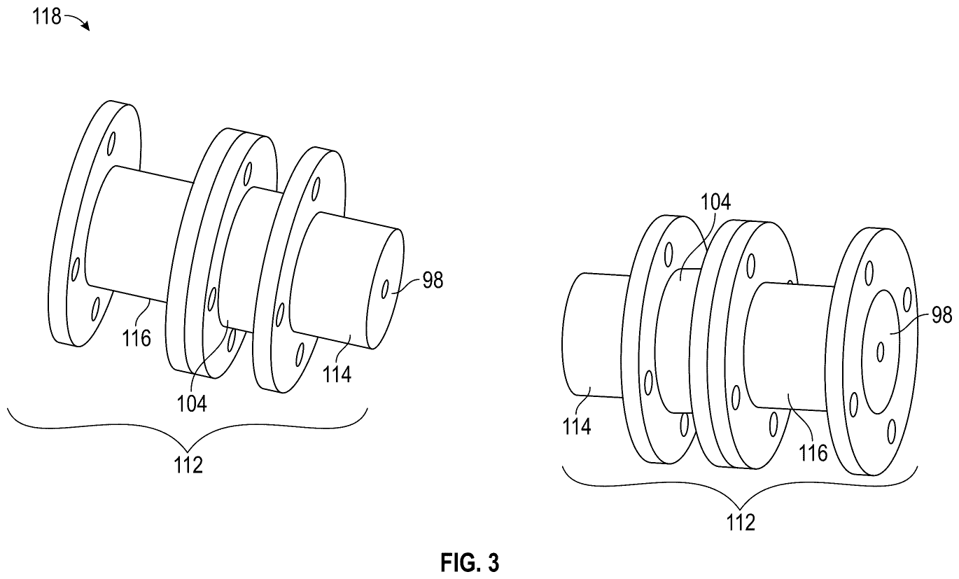

FIG. 3 shows nozzles and nozzle spacers system 118. Each nozzle 112 comprises upper base section 116 and base section 114 disposed through nozzle spacer 104. Channel 98 is disposed through the center of nozzle 112.

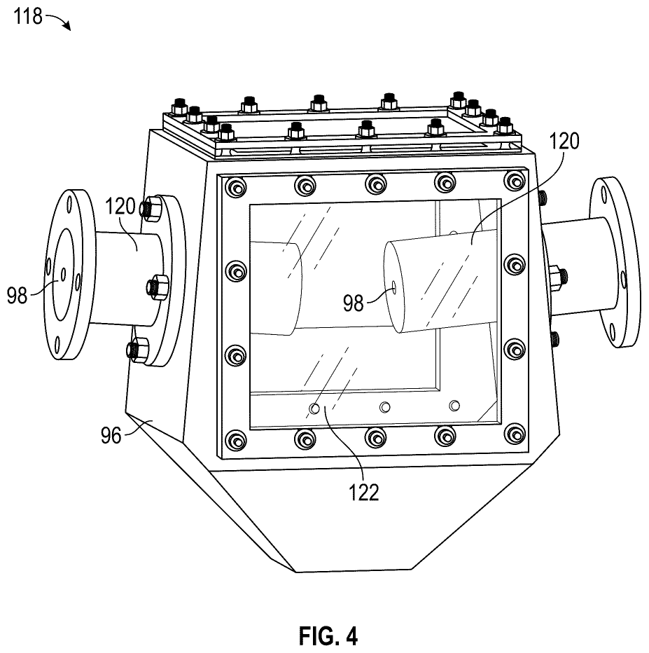

FIG. 4 shows collision chamber 118. Collision chamber 118 comprises housing 96 and viewing window 122. Embedded nozzles 120 are partially disposed within collision chamber 118 at oblique angles to one another. Channels 98 are disposed through the centers of embedded nozzles 120.

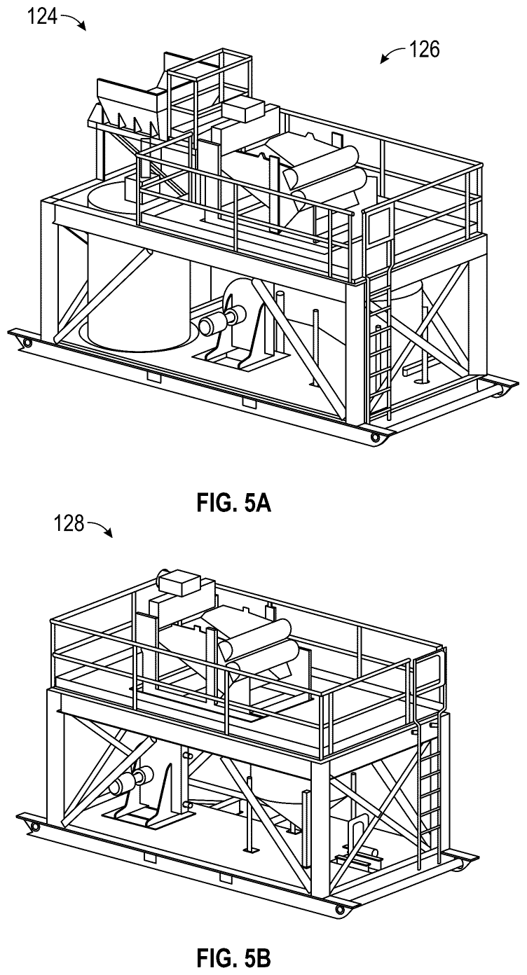

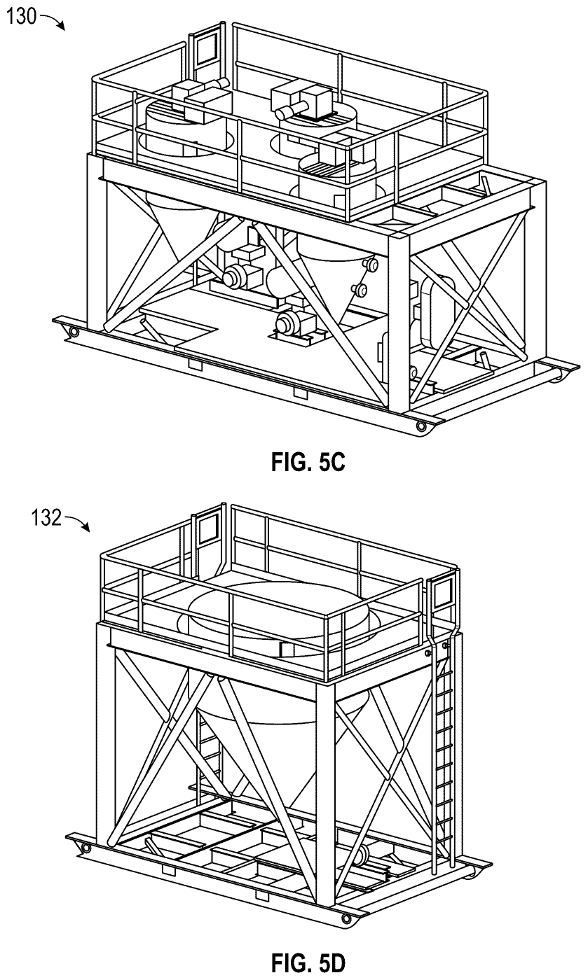

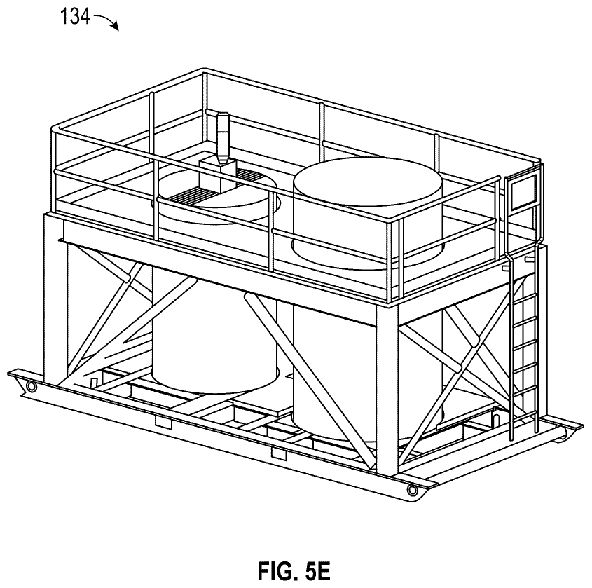

FIGS. 5A, 5B, 5C, 5D and 5E show skid components 124. FIG. 5A shows primary screen skid 126. FIG. 5B shows secondary screen skid 128. FIG. 5C shows high pressure slurry ablation tank skid 130. FIG. 5D shows clarifier skid 132. FIG. 5E shows recycle and raw water tank skid 134.

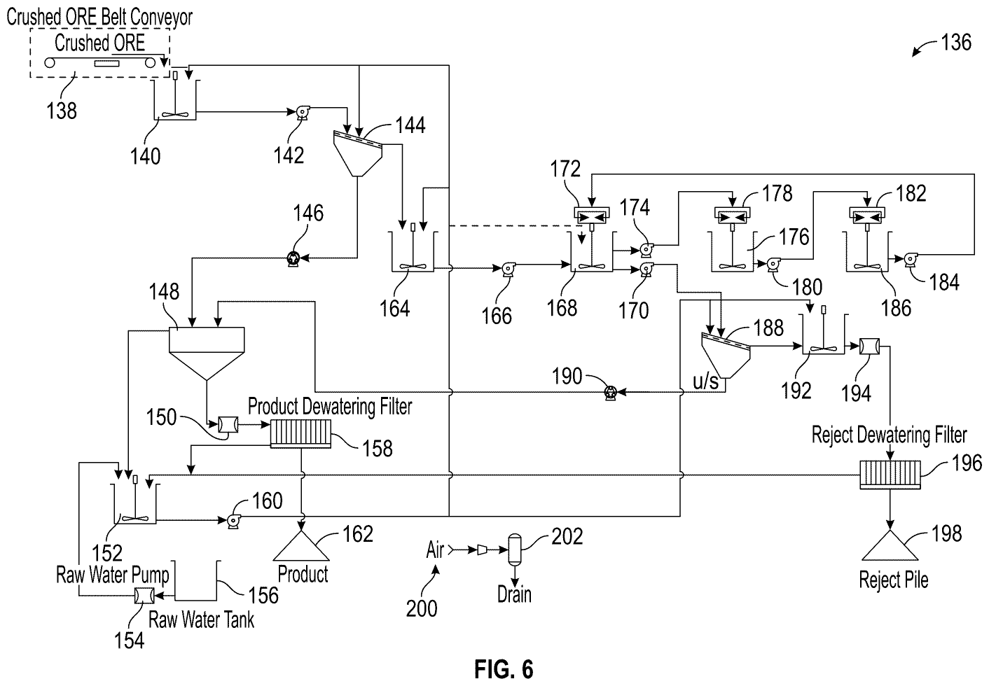

FIG. 6 shows system 136. Crushed ore belt conveyor 138 transports ore to mixing vessel 140 to form a slurry. Slurry is then transported via centrifugal pump 142 to primary screen 144. Peristaltic pump 146 transports undersized material in a slurry to clarifier 148. Excess water is flowed into agitated recycle water tank 152. Centrifugal pump 160 transports recycled water to various processes throughout the system, including mixing vessel 140, primary screen 144, mixing vessel 164, secondary screen 188, and tank 192. Recycled water is mixed with oversize secondary screen material in mixing vessel 192 and transported by pump 194 to reject dewatering filter 196. Reject material 198 exits reject dewatering filter 196. Fluid from reject dewatering filter 196 flows into agitated recycle water tank 152. Oversize primary screen material is flowed into mixing vessel 164 and transported via pump 166 to recovery vessel 168. Pump 170 transports ablated slurry from recovery vessel 168 to secondary screen 188. Slurry is transported by pump 174 to collision chamber 178 where it is ablated. Ablated slurry enters recovery vessel 176 and transported via pump 180 to collision chamber 182 where the ablated slurry undergoes a secondary ablation. The ablated slurry then enters recovery vessel 186 and is transported via pump 184 to collision chamber 172 and enters recovery vessel 168. The ablated slurry is transported to secondary screen 188 and undersize material is transported via peristaltic pump 190 to clarifier 148. Pump 150 transports ablated slurry from clarifier 148 to product dewatering filter 158. Product 162 exits product dewatering filter 158 after dewatering. Optionally, ablated slurry may be transported to collision chamber 178 via pump 174.

Fluid balances in system 136 are maintained by flowing raw water from raw water tank 156 into agitated recycle water tank 152 via raw water pump 154. System 136 is in communication with drain 202. Fluid from agitated recycle water tank 152 may also be flowed into mixing vessel 140. Compressed air 200 may enter a plurality of system sections and may be used to operate pumps throughout the system.

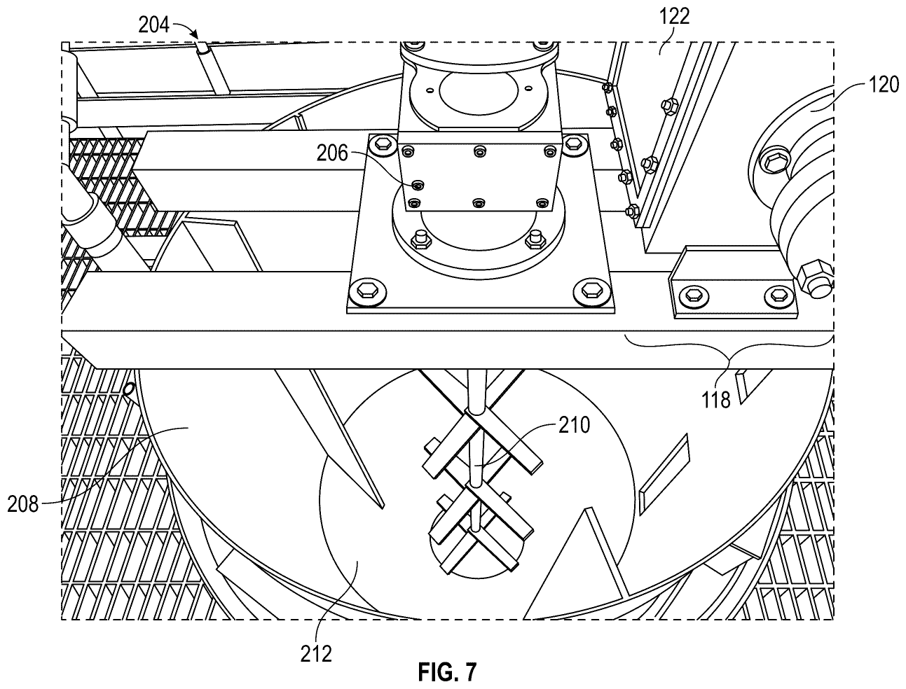

FIG. 7 shows recovery tank with mechanical agitator 204. Recovery tank with mechanical agitator 204 comprises collision chamber 118 disposed above recovery tank shell 208 forming cavity 212. Collision chamber 118 comprises embedded nozzle 120 and viewing window 122. Motor 206 is attached to mechanical agitator 210 and disposed above recovery tank shell 208. Heterogeneous material flows through embedded nozzle 120 and into collision chamber 118. Heterogeneous material ablation may be viewed via viewing window 122. Ablated heterogeneous material then flows into cavity 212 where it is agitated and/or mixed by mechanical agitator 210.

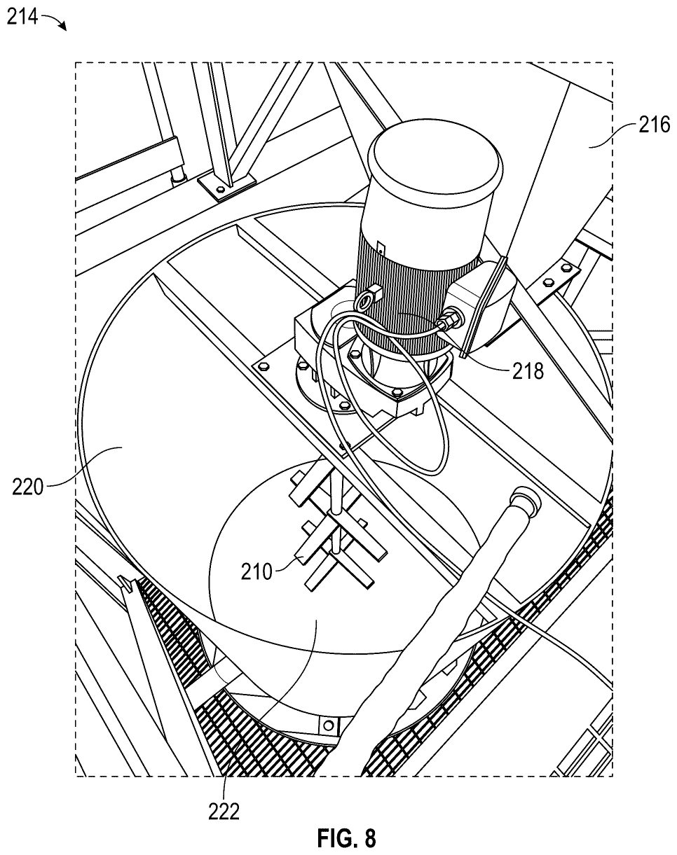

FIG. 8 shows mixing tank with mechanical agitator 214. Mixing tank with mechanical agitator 214 comprises hopper 216 disposed above cavity 222 of mixing tank 220. Motor 218 is attached to mechanical agitator 210 and is disposed above cavity 222. Heterogeneous material in hopper 216 flows into mixing tank 220 where it is mixed by mechanical agitator 210.

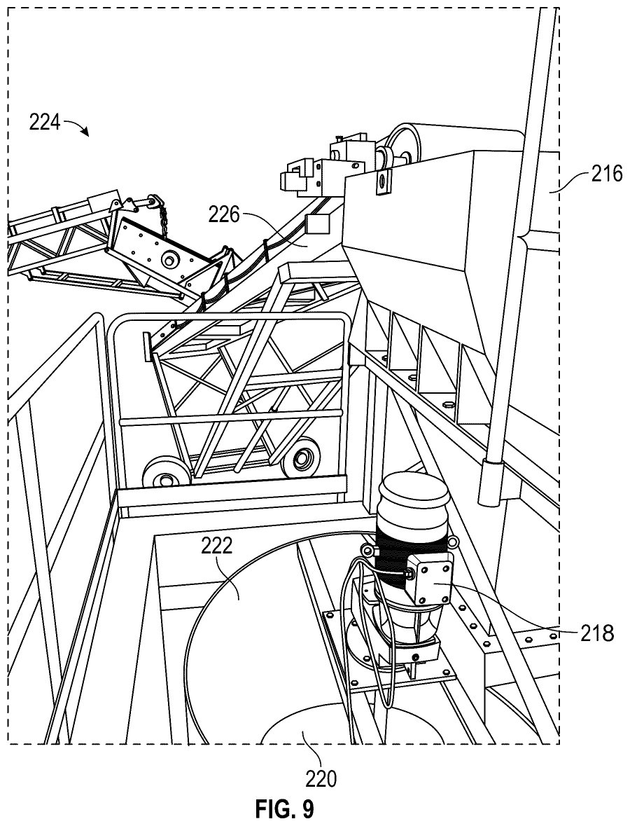

FIG. 9 shows ore conveyor and mixing tank 224. Ore conveyor and mixing tank 224 comprises conveyor 226, hopper 216, mixing tank 220 and motor 218. Ore is transported by conveyor 226 into hopper 216 and flows into cavity 222 of mixing tank 220 where the ore is then mixed by a mechanical agitator (not shown) powered by motor 218.

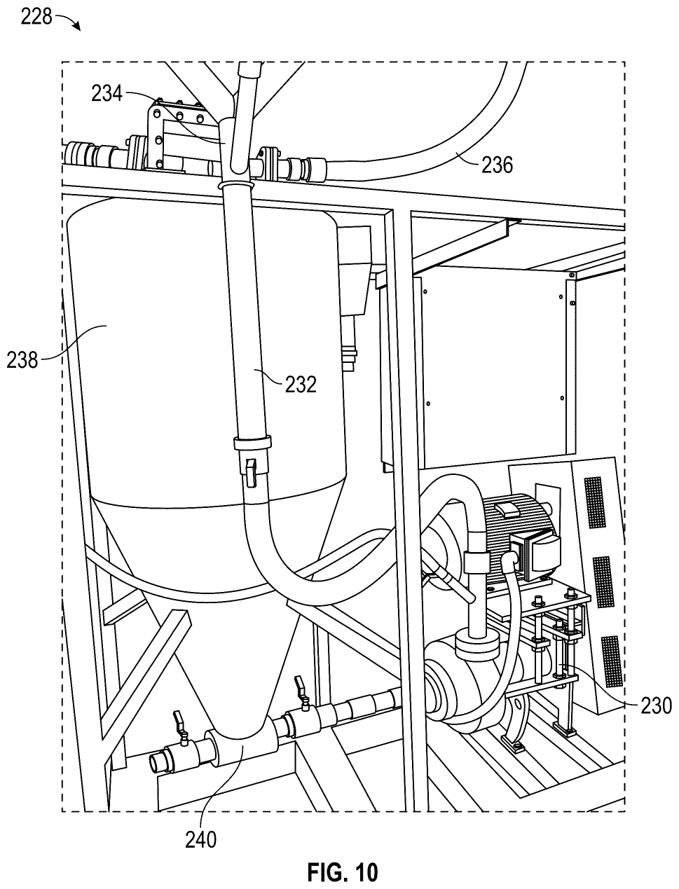

FIG. 10 shows pump orientation and stream splitter 228. Impeller pump orientation and stream splitter 228 comprises impeller pump 230 in communication with conduit 240. Conduit 240 is in communication with splitter 234. Splitter 234 is in communication with conduit 236. Conduit 236 is in communication with vessel 238 comprising base 232. Heterogeneous material is pumped into conduit 240, split by splitter 234 and flowed into vessel 238.

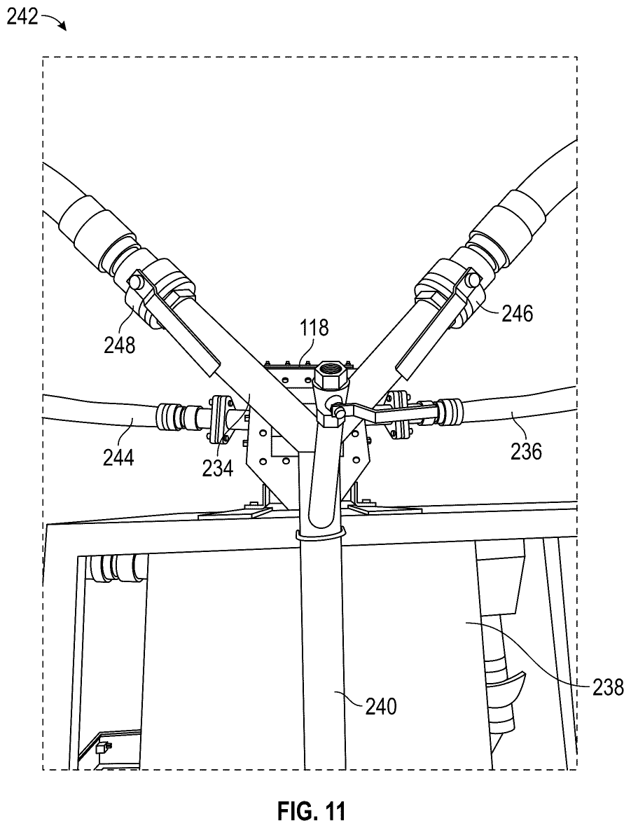

FIG. 11 shows splitter and flow adjustment valves 242. Splitter and flow adjustment valves 242 comprise conduit 240 in communication with splitter 234. Splitter 234 is in communication with valve 246 and valve 248. Valve 246 is in communication with conduit 236, and valve 248 is in communication with conduit 244. Conduits 236 and 244 are in communication with collision chamber 118. Collision chamber 118 is in communication with vessel 238. A flow of heterogeneous material is split by splitter 234, and each split flow passes through conduits 236 and 244 to undergo ablation in collision chamber 118 before entering vessel 238. Valves 246 and 248 may be used to adjust the flow rate of heterogeneous material into conduits 236 and 244.

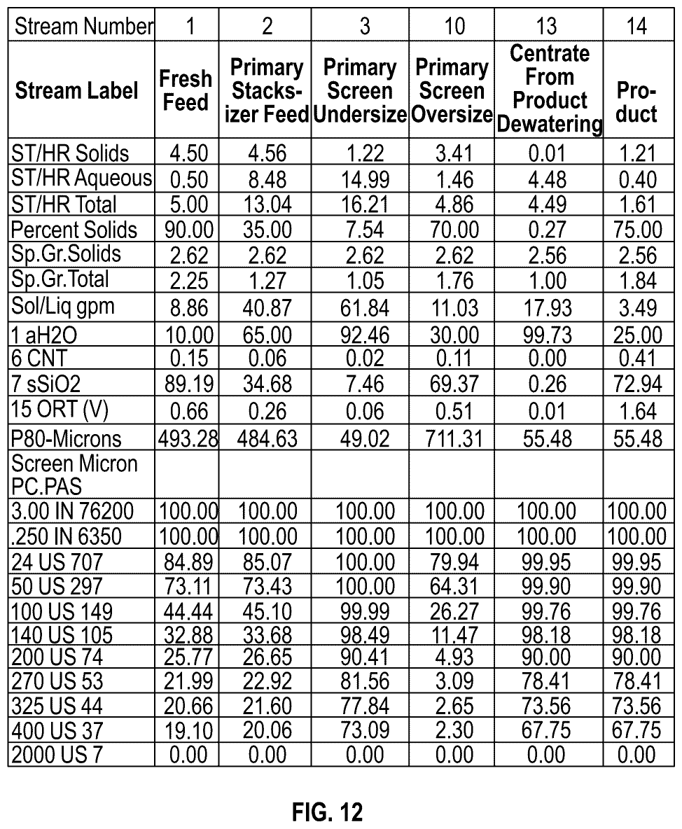

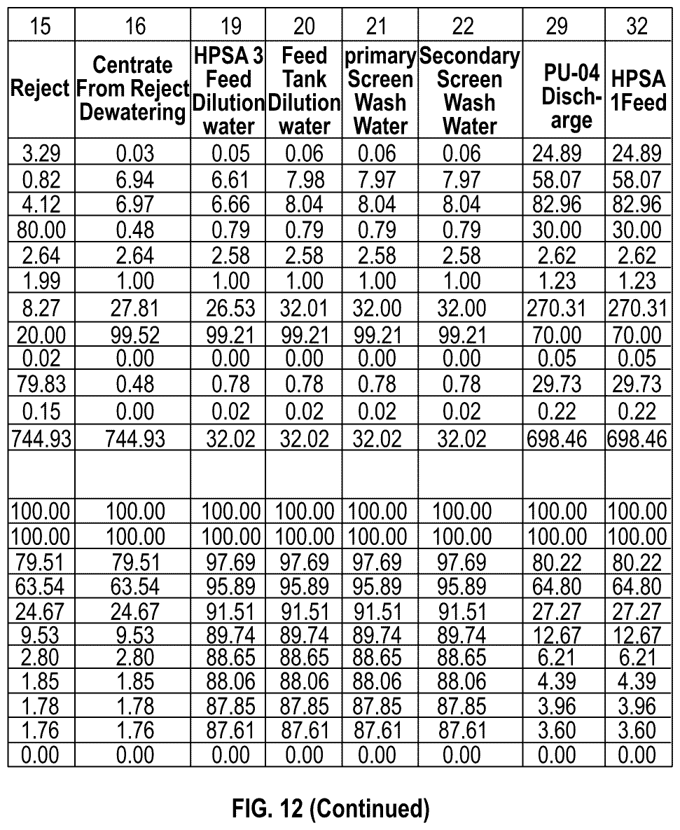

FIG. 12 shows the mass balance for a system. The mass balance analysis shows product and reject mass streams.

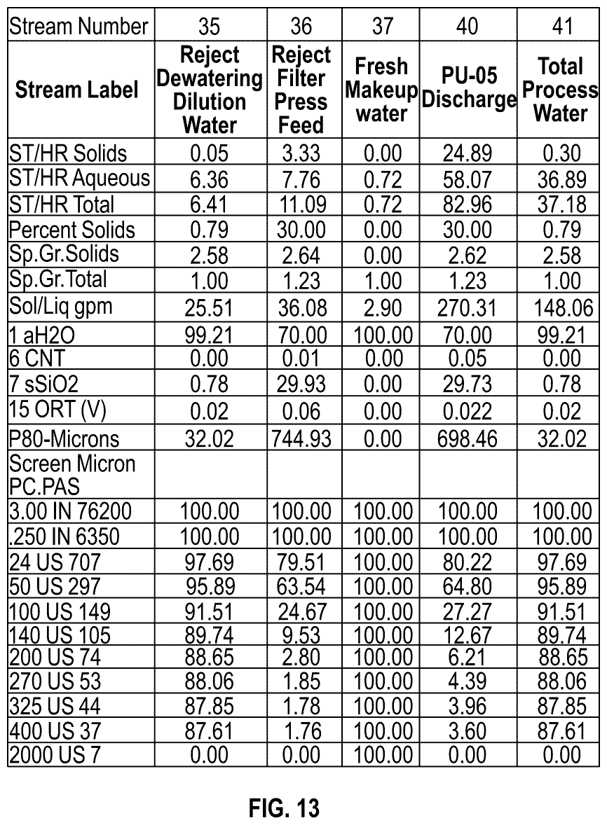

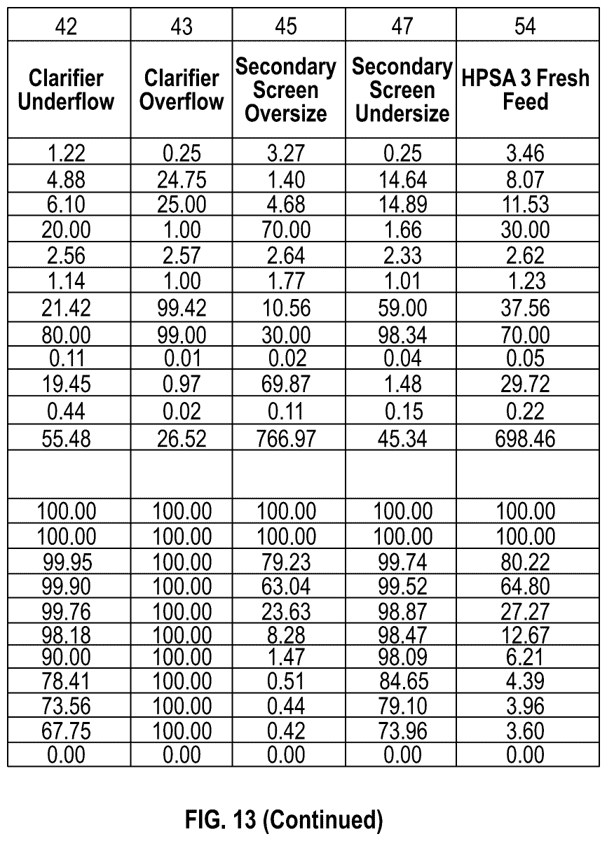

FIG. 13 shows the mass balance for a system. The mass balance analysis shows process water and clarifier conditions.

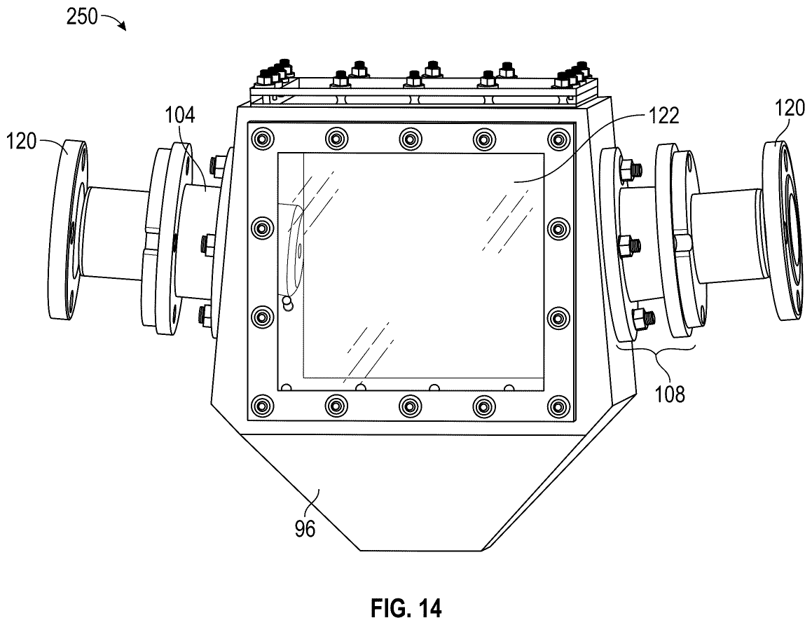

FIG. 14 shows collision chamber 250. Collision chamber 250 comprises embedded nozzles 120, spacer ring 104, housing 96, and viewing window 122. Embedded nozzle 120 is disposed through housing 96. Spacer 104 is disposed around a portion of embedded nozzle 120 and forms length 108 between housing 96 and an end of embedded nozzle 120.

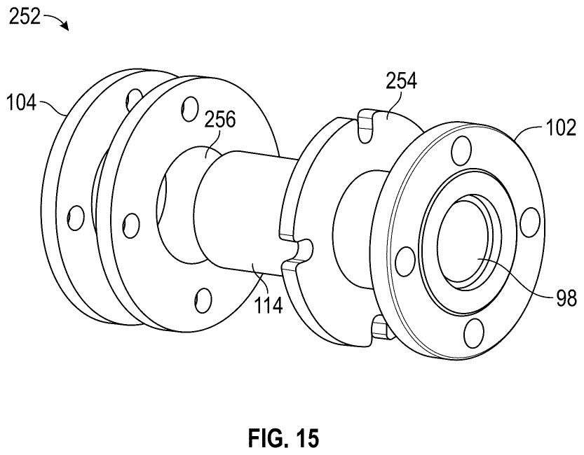

FIG. 15 shows nozzle and nozzle spacer system 252. Nozzle and nozzle spacer system 252 comprises spacer ring 104 and base section 114. Base section 114 comprises proximal ring 254 and distal ring 102. Channel 98 is disposed through base section 114. Base section 114 is disposed into channel 256 of spacer ring 104, which contacts proximal ring 254.

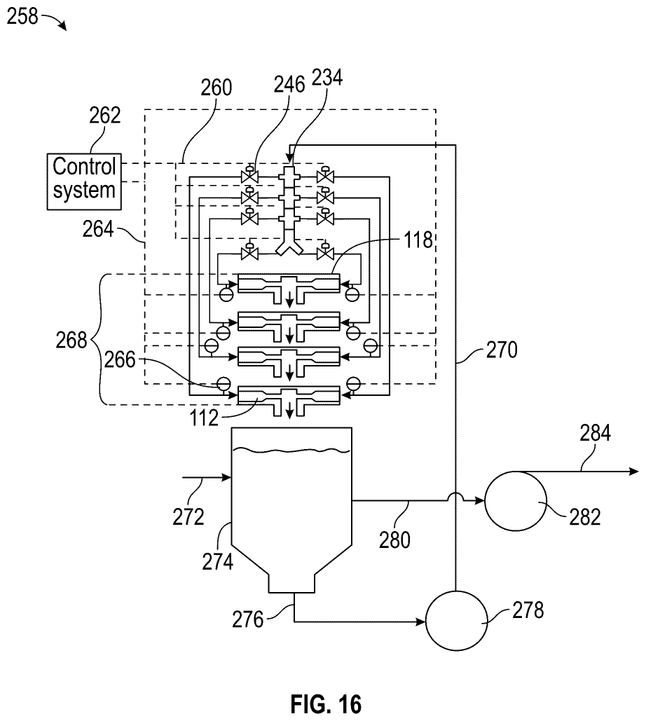

FIG. 16 shows system for processing heterogeneous material 258 comprising collision array 268. System for processing heterogeneous material 258 further comprises control system 262, control system conduits 260, adjustment valves 246, splitter 234, control system data 264, transducers 266, collision chamber 118, nozzle 112, recirculation conduit 270, catch tank 274, recirculation collision pump intake conduit 276, recirculation collision pump 278, process out inlet 280, and process draw-off pump 282. Heterogeneous material enters system for processing heterogeneous material 258 as system inlet stream 272 and into catch tank 274. Heterogeneous material passes through recirculation collision pump intake conduit 276 and into recirculation collision pump 278. Heterogeneous material then passes from recirculation collision pump 278, through recirculation conduit 270, and enters splitter 234. Splitter 234 separates heterogeneous material into portions and the separated heterogeneous material enters collision array 268. Collision array 268 comprises a plurality of individual collision chambers 118. Heterogeneous material is ablated in collision chambers 118. Collision chambers 118 comprise at least one nozzle 112 and are configured to ablate the heterogeneous material. Ablated heterogeneous material enters catch tank 274 and a portion of the ablated heterogeneous material enters process out inlet 280. Process draw-off pump 282 conveys ablated heterogeneous material out of system for processing heterogeneous material 258 as process out discharge 284. Transducers 266 transmit ablation-related information including, but not limited to, flow rate and velocity, to control system data 264 to be analyzed by control system 262. Control system conduits 260 transmit data that is analyzed by control system 262. Optionally, the amount of separated heterogeneous material entering either side of collision chamber 118 may be adjusted by adjustment valve 246 as directed by control system 262.

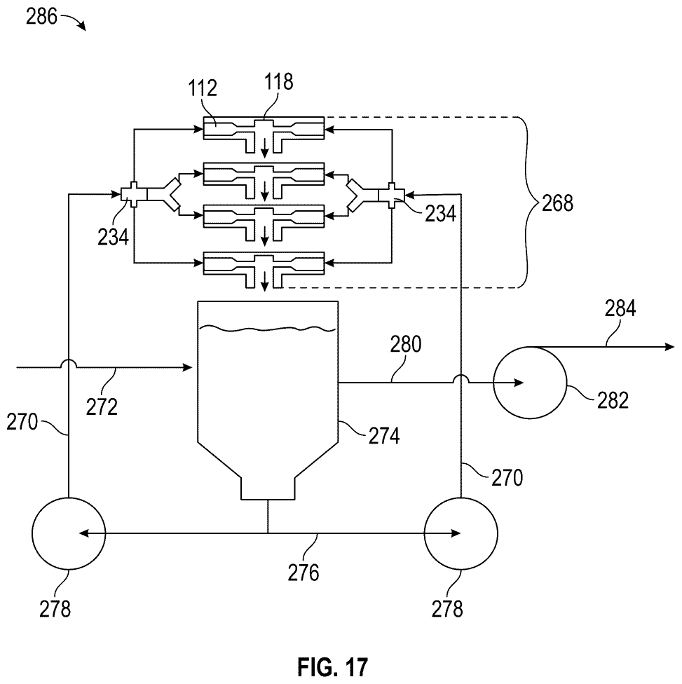

FIG. 17 shows a system for processing heterogeneous material 286 comprising a plurality of recirculation collision pumps 278. System for processing heterogeneous material 286 further comprises catch tank 274, recirculation collision pump intake conduit 276, recirculation conduits 270, splitter 234, collision chamber array 268, collision chamber 118, nozzle 112, process out inlet 280, and process draw-off pump 282. Recirculation collision pump 278 comprises intakes (not shown) in communicating with conduit 276 and catch tank 274. Heterogeneous material enters system for processing heterogeneous material 286 as system inlet stream 272 and into catch tank 274. Heterogeneous material passes through recirculation collision pump intake conduit 276 and into recirculation collision pumps 278. Heterogeneous material then passes from recirculation collision pumps 278, through recirculation conduits 270 and enters splitters 234. Splitter 234 separates heterogeneous material into portions and the separated heterogeneous material enters collision array 268. Collision array 268 comprises a plurality of individual collision chambers 118. Collision chambers 118 comprise at least one nozzle 112 and ablated heterogeneous material. Ablated heterogeneous material enters catch tank 274 and a portion of the ablated heterogeneous material enters process out inlet 280. Process draw-off pump 282 conveys ablated heterogeneous material out of system for processing heterogeneous material 286 as process out discharge 284.

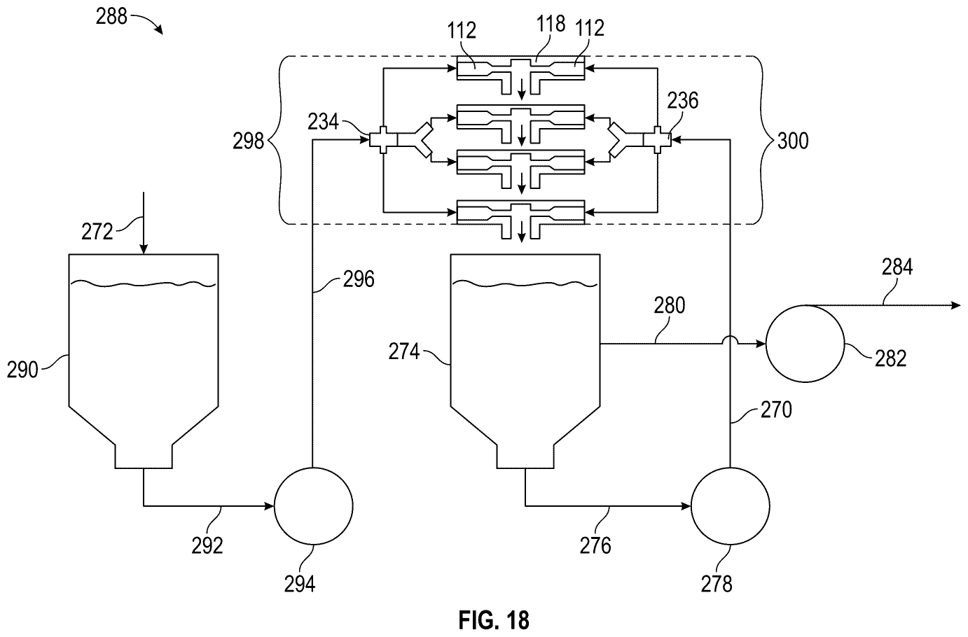

FIG. 18 shows a system for processing heterogeneous material 288 comprising system inlet tank 290. System for processing heterogeneous material 288 further comprises transfer collision pump intake conduit 292, transfer collision pump 294, transfer collision pump conduit 296, splitter 234, transfer collision pump collision array 298, collision chamber 118, nozzle 112, recirculation collision pump intake conduit 276, recirculation collision pump 278, recirculation conduit 270, recirculation collision pump collision array 300, catch tank 274, process out inlet 280, and process draw-off pump 282. Heterogeneous material enters system for processing heterogeneous material 288 as system inlet stream 272 and into system inlet tank 290. Heterogeneous material passes through transfer collision pump intake conduit 292 and into transfer collision pump 294. Heterogeneous material exits transfer collision pump 294 and into transfer collision pump conduit 296. Heterogeneous material passes out of transfer collision pump conduit 296 and enters splitter 234. Splitter 234 separates heterogeneous material into portions and the separated heterogeneous material enters collision array fed by transfer pump 298. Collision array fed by transfer pump 298 comprises a plurality of individual collision chambers 118. Each collision chamber 118 comprises at least one nozzle 112. Heterogenous material is ablated by plurality of collision chambers 118. Ablated heterogeneous material enters catch tank 274. Ablated heterogeneous material exits catch tank 274, passes through recirculation collision pump intake conduit 276 and enters recirculation collision pump 278. Ablated heterogeneous material exits recirculation collision pump 278, passes through recirculation conduit 270 and enters splitter 236. Splitter 236 separates ablated heterogenous material into portions and the ablated separated heterogenous material enters collision array 300 fed by recirculation pump 278. Collision array 300 fed by recirculation pump 278 comprises a plurality of individual collision chambers 118. Each collision chamber 118 comprises at least one nozzle 112. Collision chambers 118 re-ablate the heterogenous material. Re-ablated heterogeneous material exists collision chambers 118 and enters catch tank 274. Ablated and/or re-ablated heterogenous material exits catch tank 274 and enters process out inlet 280. Process draw-off pump 282 conveys ablated heterogeneous material out of system for processing heterogeneous material 288 as process out discharge 284.

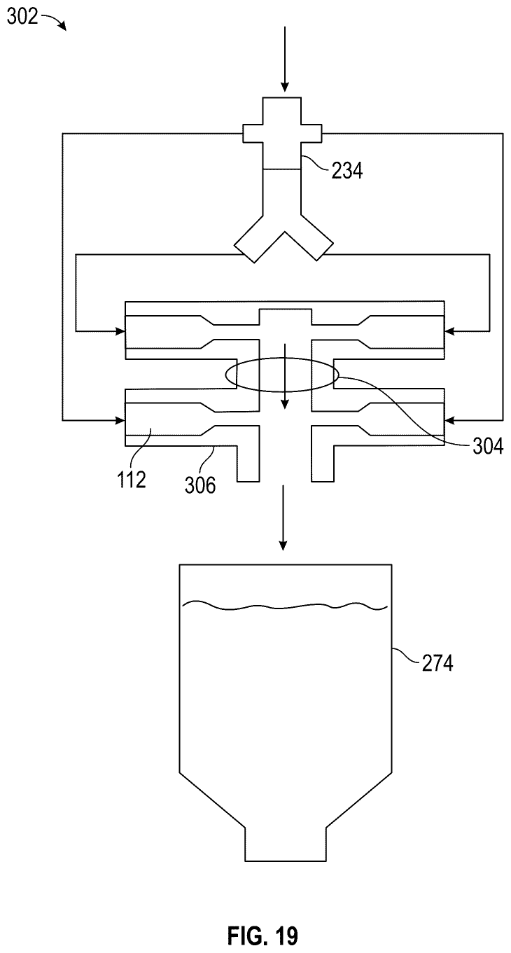

FIG. 19 shows a system for processing heterogeneous material 302 comprising combined chamber array 306. System for processing heterogeneous material 302 further comprises splitter 234 and catch tank 274. Combined chamber array 306 comprises at least one nozzle 112 and forms inter-collision region space 304. Heterogeneous material enters splitter 234 and is separated into portions. Separated heterogeneous material enters nozzle 112 of combined chamber array 306. Heterogeneous material passes through inter-collision region space 304 of combined chamber array 306 and enters catch tank 274.

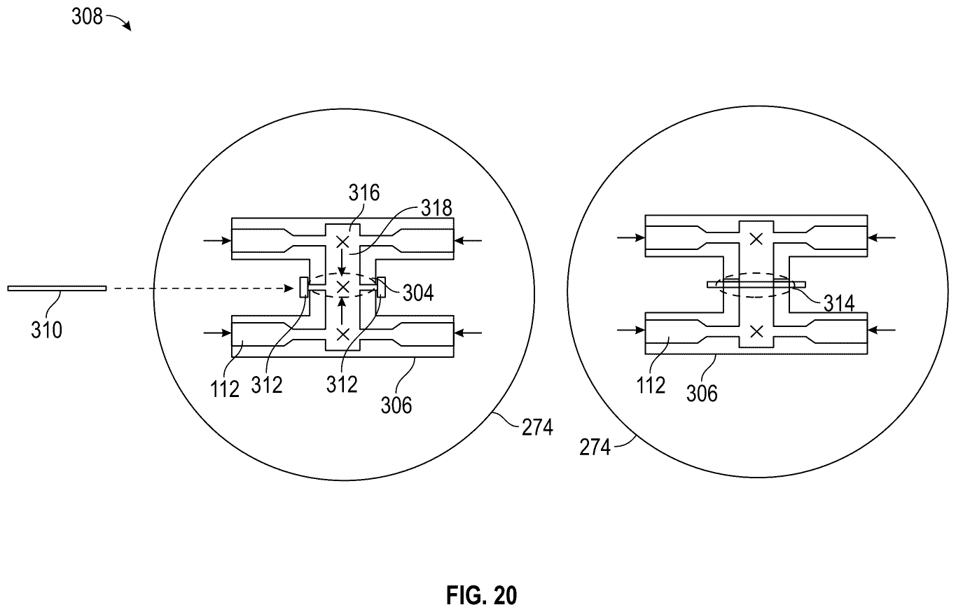

FIG. 20 shows system for processing heterogeneous material 308 comprising inter-collision separation device 310. System for processing heterogeneous material 308 further comprises combined chamber array 306, and enclosure 312. Combined chamber array 306 forms inter-collision region space 304 and is configured to allow heterogeneous material to travel along paths 316 and 318. Path 318 shows an “X” to indicate the heterogeneous material flow of collected heterogeneous materials out of the plane of view into catch tank 274. Combined chamber array 306 comprises at least one nozzle 112. Inter-collision separation device 310 is disposed into inter-collision region space 304 and is installed into position 314.

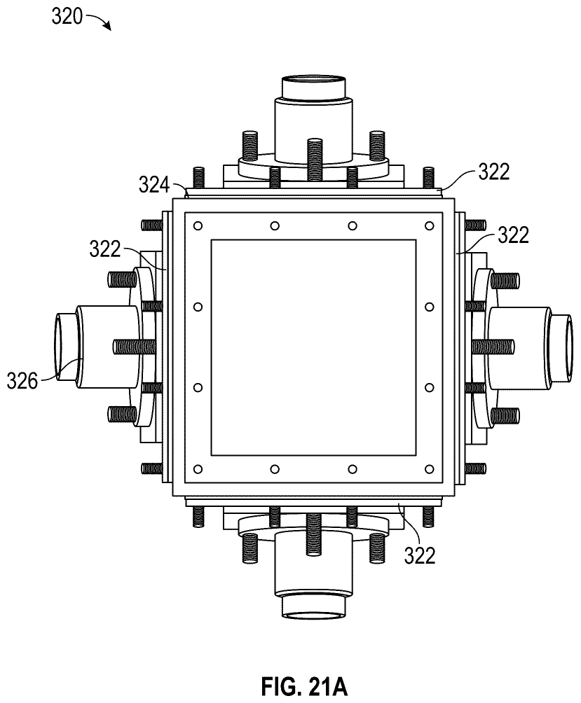

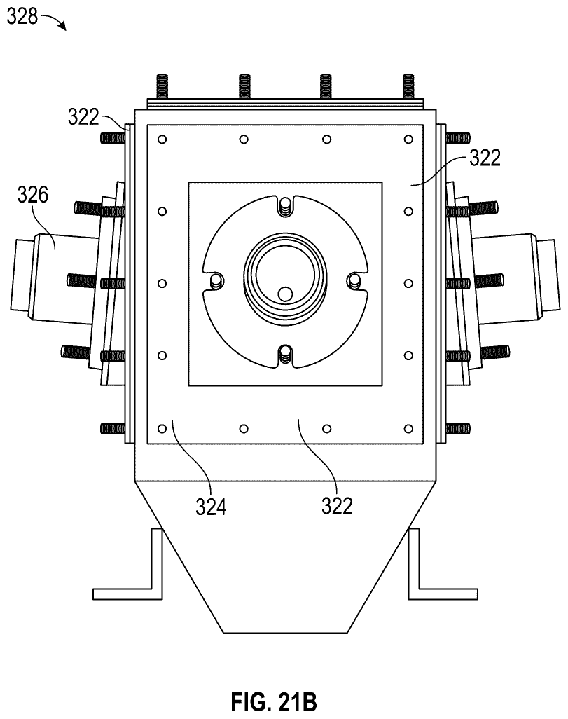

FIGS. 21A and 21B show collision chambers 320 and 328, respectively, comprising angled adapters 322. FIG. 21A shows a top-down view of collision chamber 320 comprising housing 324, nozzle fitting 326 and angled adapters 322. FIG. 21B shows a side view of collision chamber 328 comprising housing 324, nozzle fitting 326 and angled adapters 322. The rear angled adaptor is indicated by the dashed line.

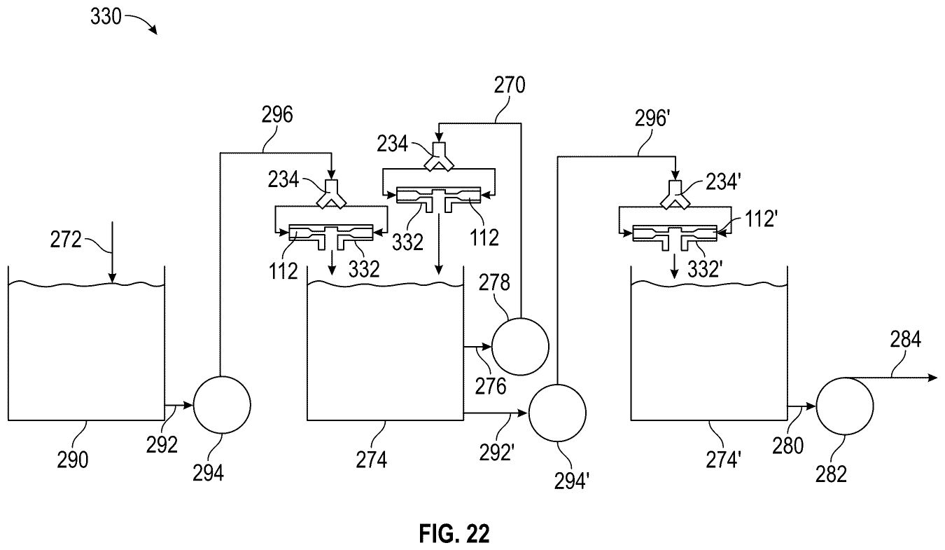

FIG. 22 shows a system for processing heterogeneous material 330 comprising plurality of catch tanks 274 and 274′. System for processing heterogeneous material 330 further comprises system inlet tank 290, transfer collision pump intake conduits 292 and 292′, transfer collision pumps 294 and 294′, transfer collision pump conduits 296 and 296′, splitters 234 and 234′, variable collision arrays 332 and 332′, recirculation collision pump intake conduit 276, recirculation collision pump 278, process out inlet 280, and process draw-off pump 282. Variable collision array 332 comprises at least one nozzle 112 and may be an individual collision chamber, a collision array, or a combined chamber array. Heterogeneous material enters system for processing heterogeneous material 330 as system inlet stream 272 and into system inlet tank 290. Heterogeneous material passes through transfer collision pump intake conduit 292 and into transfer collision pump 294. Heterogeneous material exits transfer collision pump 294 and enters transfer collision pump conduit 296. Heterogeneous material exits transfer collision pump conduit 296 and enters splitter 234. Splitter 234 separates heterogeneous material into portions and the separated heterogeneous material enters variable collision array 332. Variable collision array 332 ablates heterogeneous material. Ablated heterogeneous material enters catch tank 274 from variable collision array 332. Ablated heterogeneous material exits catch tank 274 and enters collision pump intake conduit 276. Ablated heterogeneous material passes through recirculation collision pump intake conduit 276 and recirculation collision pump 278. Ablated heterogeneous material exits recirculation collision pump 278, passes through recirculation conduit 270 and enters splitter 234. Splitter 234 separates ablated heterogeneous material into portions and the ablated separated heterogenous material enters collision array 332. Variable collision array 332 re-ablates separated heterogenous material. Re-ablated heterogeneous material exits variable collision array 332 and enters catch tank 274. Ablated heterogeneous material and/or re-ablated heterogeneous material exits catch tank 274 and enters transfer collision pump intake conduit 292′. Ablated heterogeneous material and/or re-ablated heterogeneous material passes through transfer collision pump intake conduit 292′ and enters transfer collision pump 294′. Ablated and/or re-ablated heterogeneous material exits transfer collision pump 294′, passes through transfer collision pump conduit 296′, and enters splitter 234′. Splitter 234′ separates ablated and/or re-ablated heterogeneous material into portions and the separated ablated and/or re-ablated heterogeneous material enters variable collision array 332′. Variable collision array 332′ comprises at least one nozzle 112′ and may be an individual collision chamber, a collision array, or a combined chamber array. Re-ablated heterogeneous material enters catch tank 274′. Re-ablated heterogeneous material exits catch tank 274′ and enters process out inlet 280, and process draw-off pump 282. Process draw-off pump 282 conveys ablated and/or re-ablated heterogeneous material out of system for processing heterogeneous material 330 as process out discharge 284. Optionally, system for processing heterogenous material 330 may be designed that system for processing heterogeneous material 330 comprises a plurality of tanks, collision transfer pumps, and collision recirculation pumps.

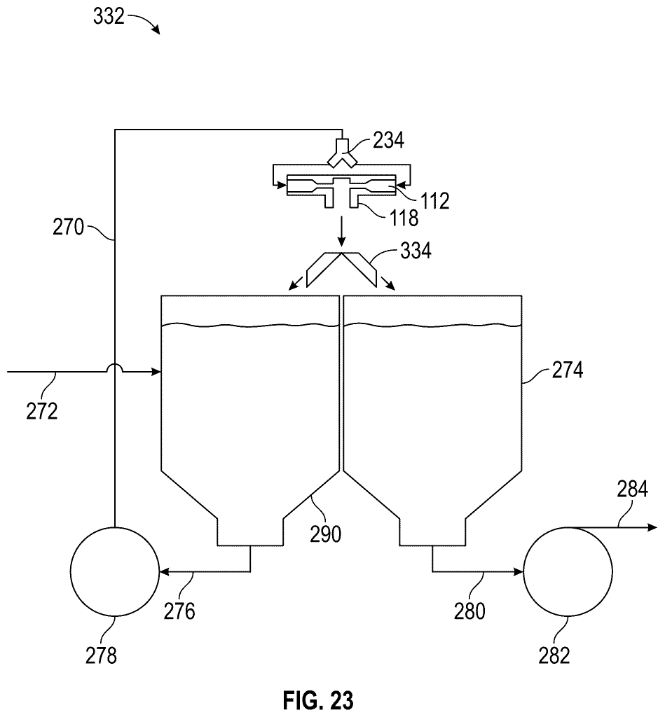

FIG. 23 shows a system for processing heterogeneous material 332 comprising flow dividing chute 334. System for processing heterogeneous material 332 further comprises system inlet tank 290, collision pump intake conduit 276, recirculation collision pump 278, recirculation conduit 270, splitter 234, collision chamber 118, catch tank 274, process out inlet 280, and process draw-off pump 282. Heterogeneous material enters system for processing heterogeneous material 332 as system inlet stream 272. Heterogeneous material passes through recirculation collision pump intake conduit 276 and into recirculation collision pump 278. Heterogeneous material then passes from recirculation collision pump 278, through recirculation conduit 270 and enters splitter 234. Splitter 234 separates heterogeneous material into portions and the separated heterogeneous material enters collision chamber 118. Collision chamber 118 comprises at least one nozzle 112. Collision chamber 118 ablates the heterogeneous material. Ablated heterogeneous material exits collision chamber 118 and enters flow dividing chute 334. Flow dividing chute 334 separates ablated heterogeneous material into system inlet tank 290 and catch tank 274. Ablated heterogenous material exits system inlet tank 290 and enters recirculation collision pump intake conduit 276. Ablated heterogenous material passes through recirculation collision pump intake conduit 276 and enters recirculation collision pump 278. Ablated heterogeneous material exits recirculation collision pump 278, passes through recirculation conduit 270, and enters splitter 234. Ablated heterogenous material exits system catch tank 274, passes through process out inlet 280, and enters process draw-off pump 282. Process draw-off pump 282 conveys ablated and/or re-ablated heterogeneous material out of system for processing heterogeneous material 332 as process out discharge 284.

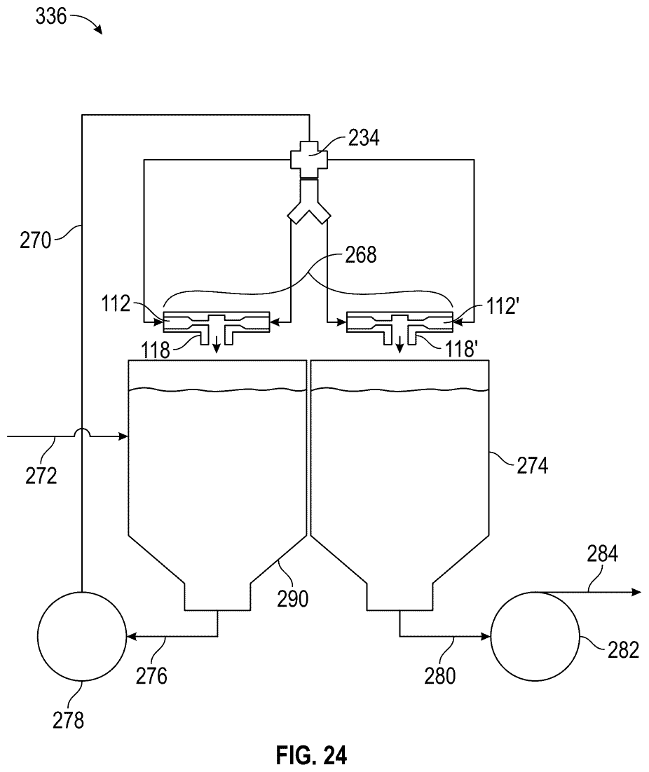

FIG. 24 shows a system for processing heterogeneous material 336 comprising splitter 234 simultaneously directing heterogeneous material into system inlet tank 290 and catch tank 274 via collision chamber array 268. System for processing heterogeneous material 336 further comprises system inlet tank 290, recirculation collision pump intake conduit 276, recirculation collision pump 278, recirculation conduit 270, catch tank 274, process out inlet 280, and process draw-off pump 282. Heterogeneous material enters system for processing heterogeneous material 336 as system inlet stream 272. Heterogeneous material enters system inlet tank 290 and passes into recirculation collision pump intake conduit 276. Heterogeneous material passes through recirculation collision pump intake conduit 276 and into recirculation collision pump 278. Heterogeneous material exits recirculation collision pump 278, passes through recirculation conduit 270, and enters splitter 234. Splitter 234 separates heterogeneous material into portions and the separated heterogeneous material enters collision array 268. Collision chamber array comprises collision chambers 118 and 118′. Collision chambers 118 and 118′ ablate the heterogeneous material and each comprise at least one nozzle 112 and 112′. Separated heterogeneous material is simultaneously ablated by collision chamber 118 and 118′. Ablated heterogeneous material from collision chamber 118 passes into system inlet tank 290. Ablated heterogenous material exits system inlet tank 290, passes through recirculation collision pump intake conduit 276 and into recirculation collision pump 278. Ablated heterogeneous material exits recirculation collision pump 278, passes through recirculation conduit 270, and enters splitter 234. Ablated heterogeneous material from collision chamber 118′ passes into catch tank 274. Ablated heterogenous material exits catch tank 274, passes through process out inlet 280, and enters process draw-off pump 282. Process draw-off pump 282 conveys ablated and/or re-ablated heterogeneous material out of system for processing heterogeneous material 336 as process out discharge 284.

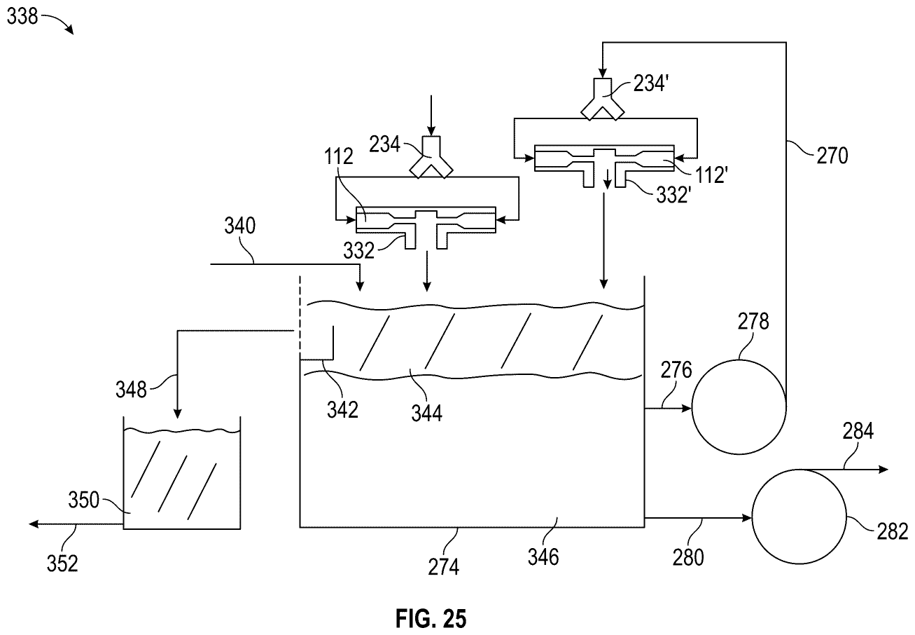

FIG. 25 shows a system for processing heterogeneous material 338 comprising overflow launder 342 and collection tank 350. System for processing heterogeneous material 338 further comprises splitters 234 and 234′, variable collision arrays 332 and 332′, catch tank 274, collision pump intake conduit 276, recirculation collision pump 278, recirculation conduits 270, overflow outlet conduit 348, process out inlet 280, and process draw-off pump 282. Heterogeneous material enters splitter 234. Splitter 234 separates heterogeneous material into portions and the separated heterogeneous material enters variable collision array 332. Variable collision array 332 comprises at least one nozzle 112 and may be an individual collision chamber, a collision array, or a combined chamber array. Variable collision array 332 ablates heterogeneous material. The ablated heterogeneous material enters catch tank 274 from variable collision array 332. The ablated heterogenous material enters recirculation collision pump intake conduit 276, passes through recirculation collision pump 278, passes through recirculation conduit 270, and enters splitter 234′. Splitter 234′ separates ablated heterogenous material into portions and the ablated heterogenous material passes into variable collision array 332′. Variable collision array 332′ comprises at least one nozzle 112′ and may be an individual collision chamber, a collision array, or a combined chamber array. Variable collision array 332′ re-ablates the ablated heterogeneous material. Re-ablated heterogenous material passes from variable collision array 332′ and into catch tank 274. Ablated and/or re-ablated heterogeneous material exits catch tank 274, passes through process out inlet 280, and enters process draw-off pump 282. Process draw-off pump 282 conveys ablated and/or re-ablated heterogeneous material out of system for processing heterogeneous material 338 as process out discharge 284. Ablated and/or re-ablated heterogeneous material in catch tank 274 forms slurry 346 and froth 344. Excess froth 344 and/or slurry 346 enters overflow launder 342. Reagent 340 may be added to slurry 346 to promote froth generation and collection of material of interest. For example, system for processing heterogeneous material 338 may be used to process graphite using methyl isobutyl carbinol as a frother and diesel fuel as a collector of material of interest. Reagent 340 may include, but is not limited to, a reagent to regulate pH, and/or other reagents that promote the collection and concentration of the material of interest. Excess slurry 346 exits catch tank 274 through overflow outlet conduit 348 and enters collection tank 350. Slurry 346 exits collection tank 350 at collection tank outlet stream 352.

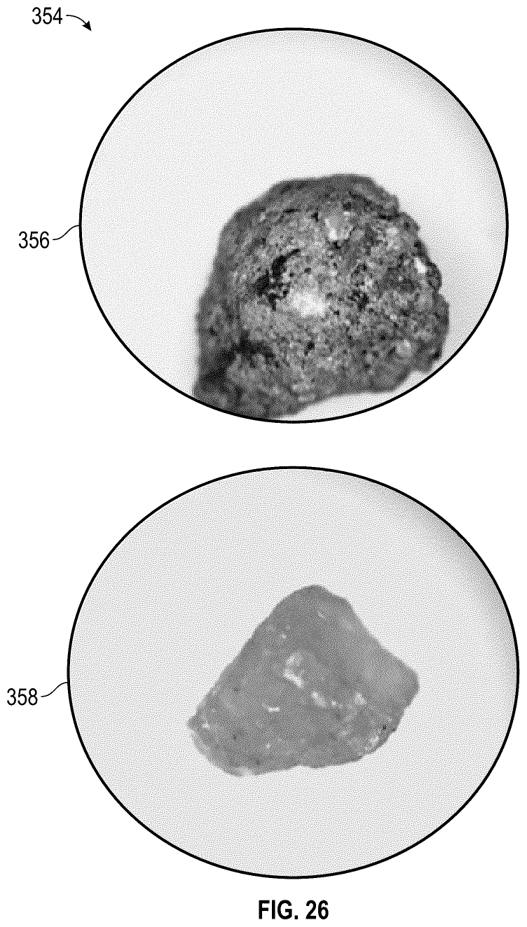

FIG. 26 shows photographs of quartz grain 354 disposed with uranium pre-HPSA 356 and post-HPSA 358.

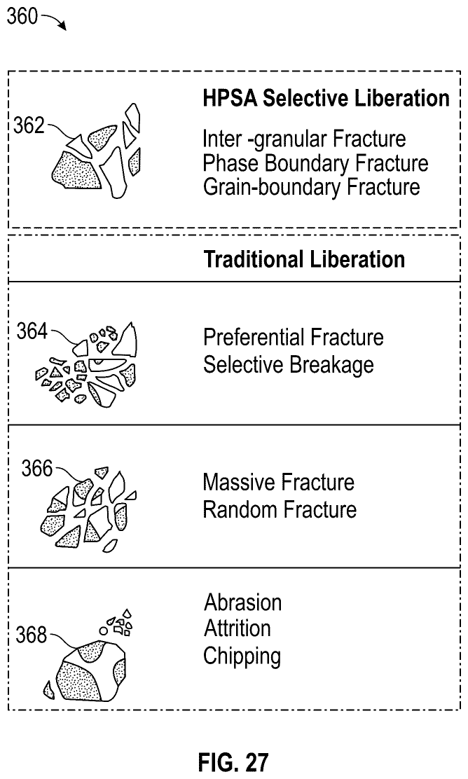

FIG. 27 shows a graphic illustration of selective liberation performed by HPSA 360. Illustration of HPSA selective liberation 362 shows crack propagation along the grain boundary of the material resulting in selective separation of material of interest from heterogenous material. Illustrations of traditional liberation including preferential separation 364, random fracture 366, and chipping 368 show reduction in size of particles of heterogenous material without selective separation of material of interest from the heterogenous material.

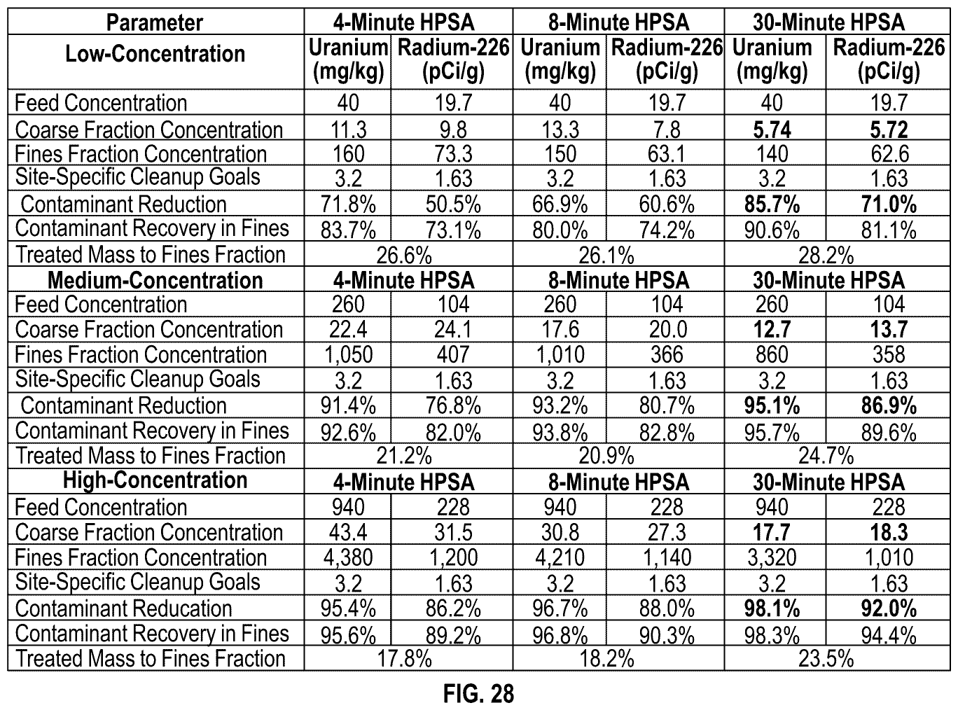

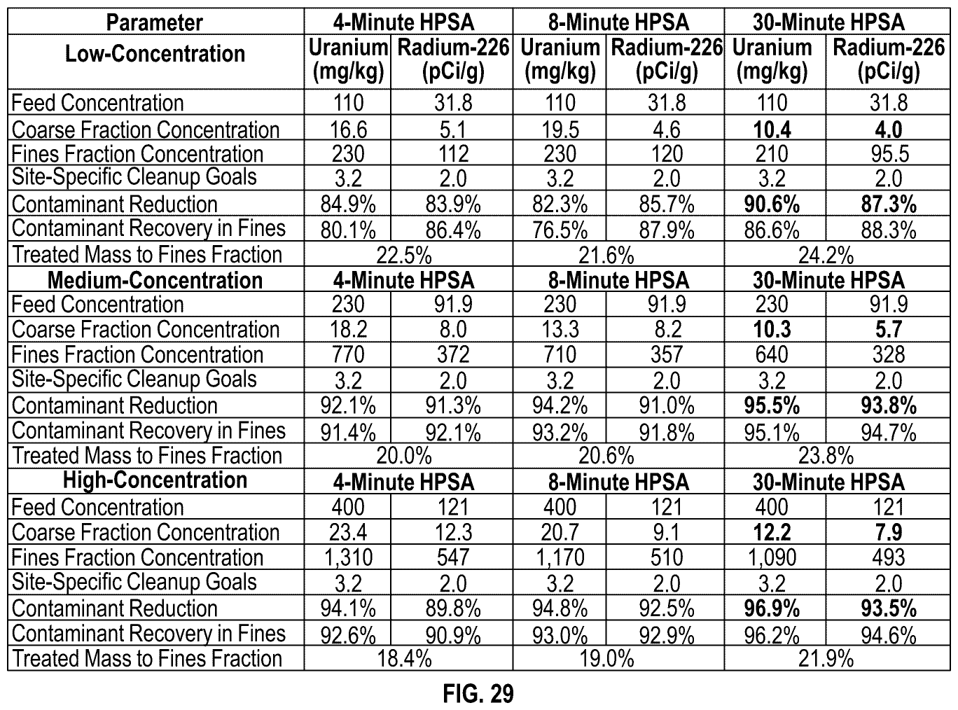

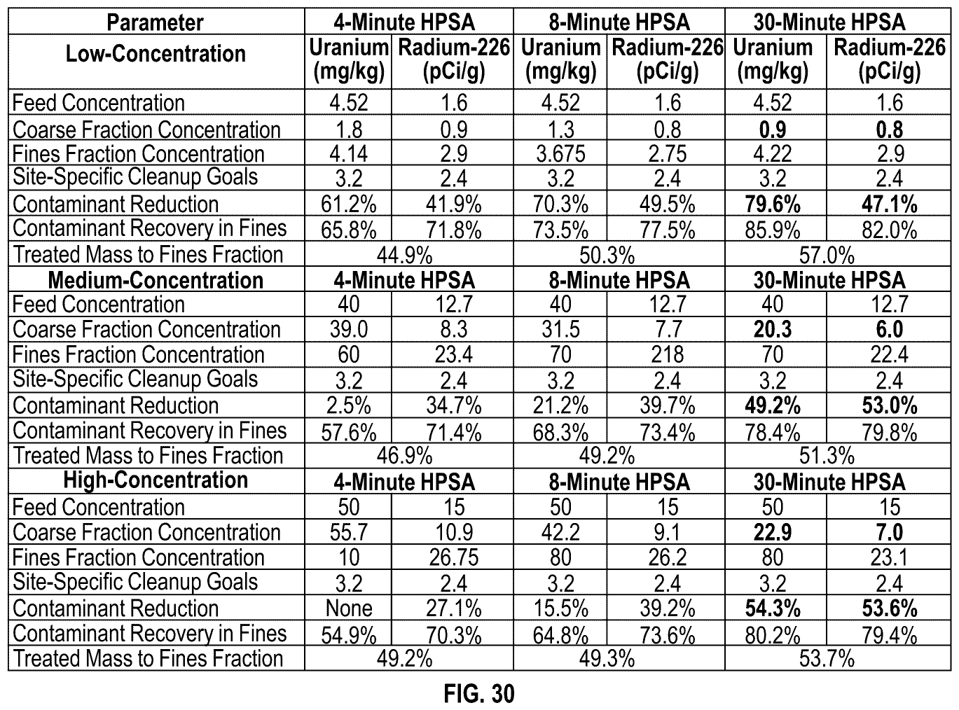

FIG. 28, FIG. 29, and FIG. 30 show a summary of heterogenous material treated with HPSA after 4 minutes, 8 minutes, and 30 minutes.

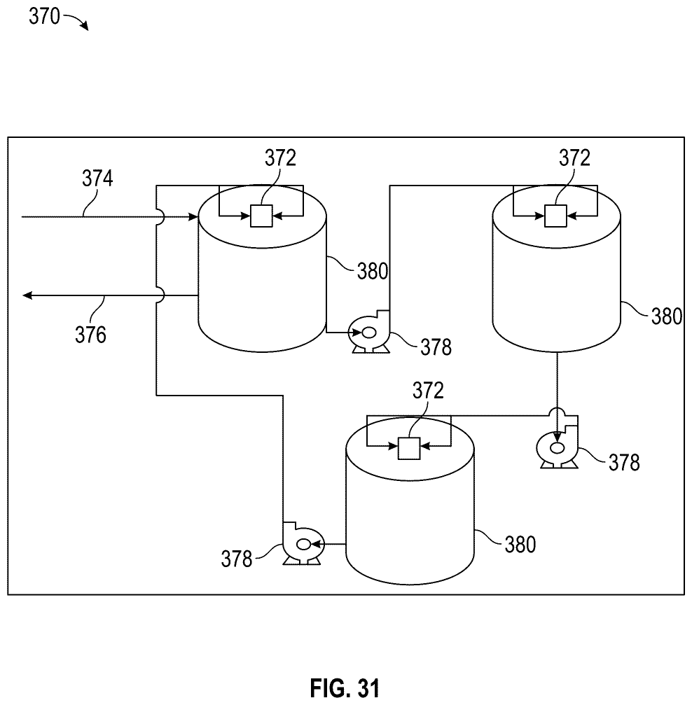

FIG. 31 shows ablation loop 370 comprising collision chamber array 372, collision pumps 378, and catch tanks 380. Feed (e.g., heterogeneous material) 374 enters ablation loop 370 where it is ablated by collision chamber array 372 and flowed through the loop by collision pumps 378 before exiting ablation loop 370 as product 376.

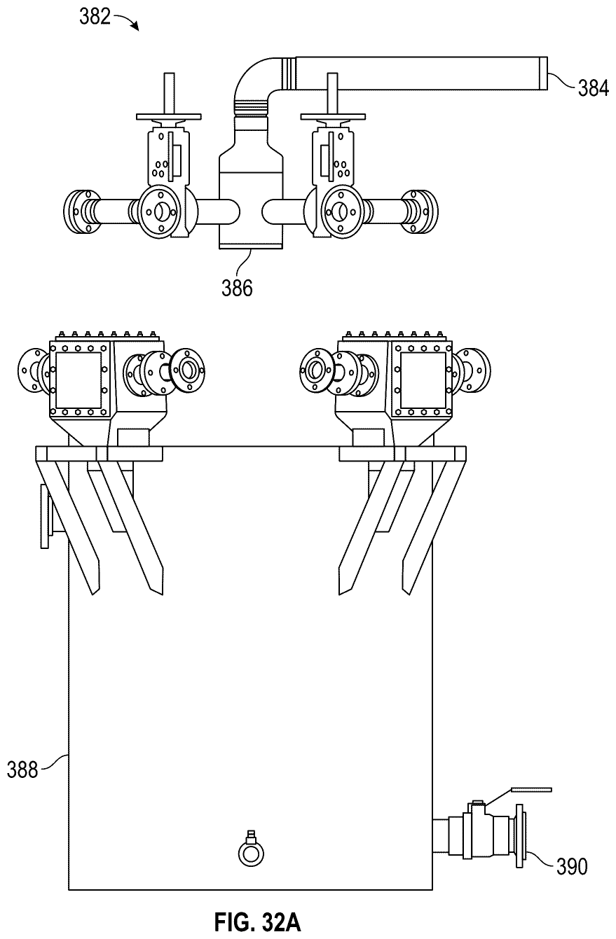

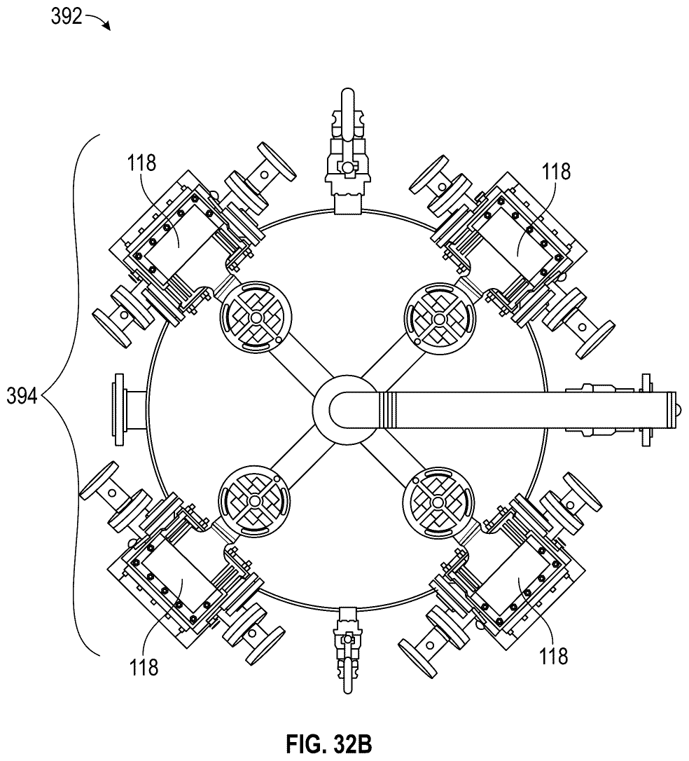

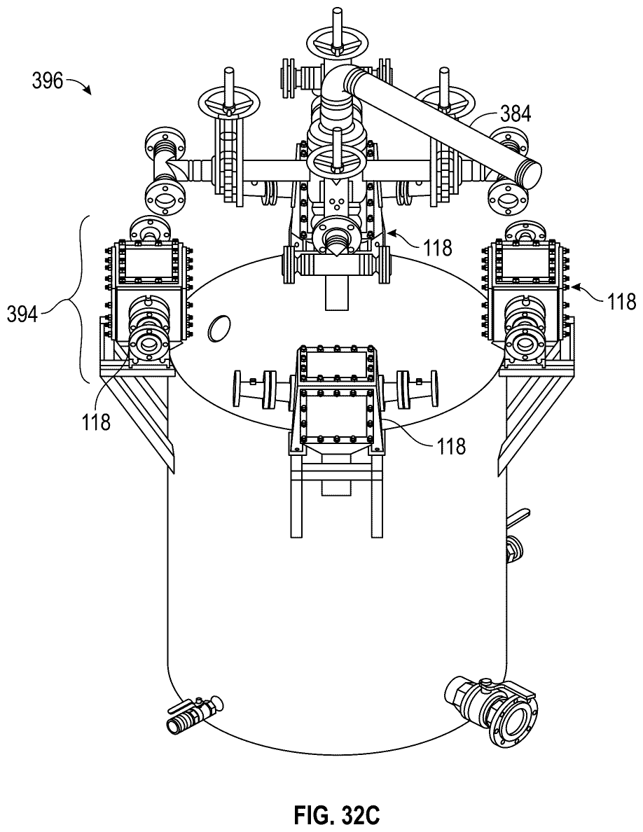

FIGS. 32A, 32B, and 32C show the side view, front view, and isometric view of radial collision chamber arrays 382, 392, and 396, respectively. Radial collision chamber arrays 382, 392, and 396 show collision chamber distributor inlet 384 in communication with collision chamber distributor 386. Collision chamber distributor 386 is in communication with collision chamber array 394. Collision chamber array 394, comprising individual collision chambers 118, is disposed between collision chamber distributor 386 and catch tank 388. Catch tank 388 is in communication with recirculation pump suction 390.

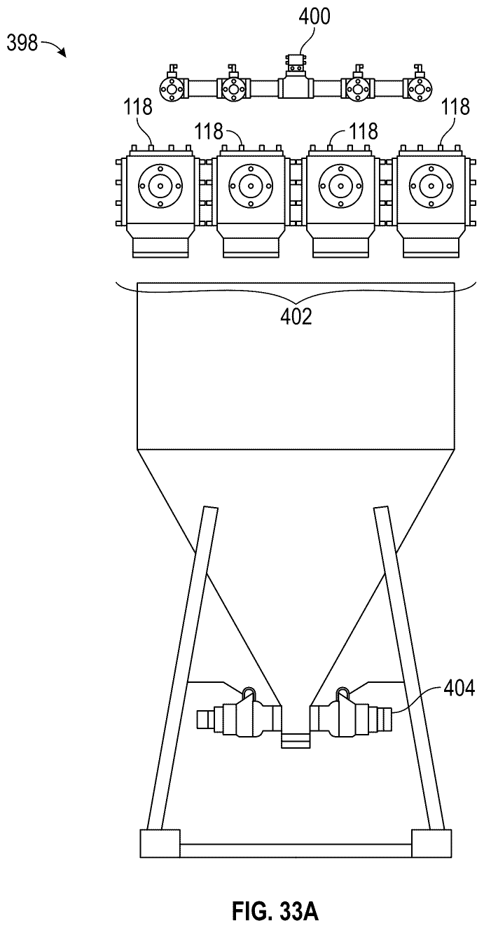

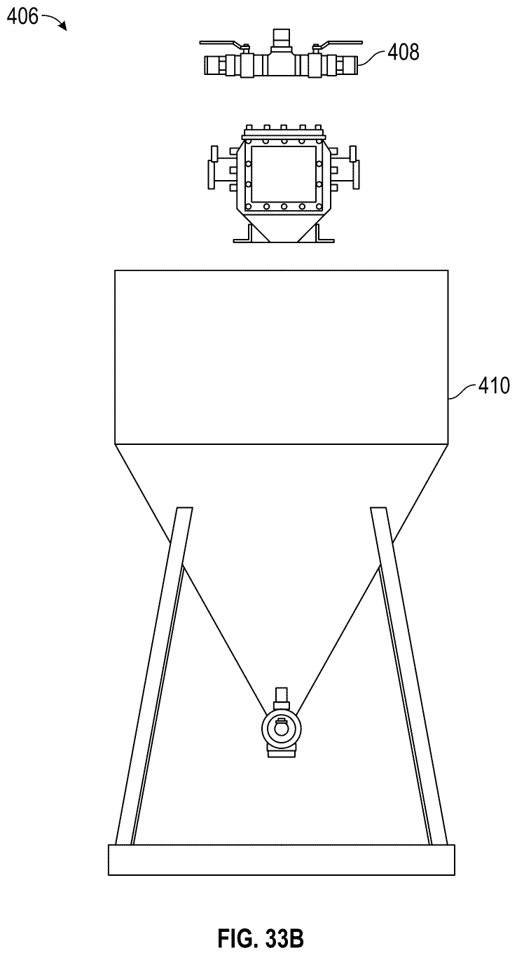

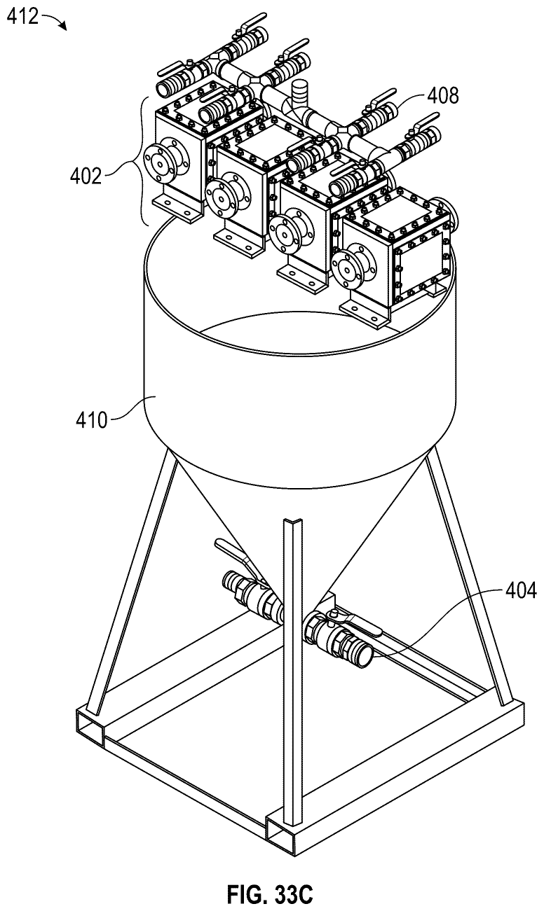

FIGS. 33A, 33B, and 33C show the side view, front view, and isometric view of linear collision chamber arrays 398, 406, and 412, respectively. Linear collision chamber arrays 398, 406, and 412 show collision chamber distributor inlet 400 in communication with collision chamber distributor 408. Collision chamber distributor 408 is in communication with collision chamber array 402. Collision chamber array 402, comprising individual collision chambers 118, is disposed between collision chamber distributor 408 and catch tank 410. Catch tank 410 is in communication with recirculation pump suction 404.

The system may be configured to dissociate a subfraction of a heterogenous material. The system may comprise a pump including, but not limited to, an intake and/or discharge pump. The system may comprise a discharge port. The system may comprise a source of heterogeneous material. The system may comprise a mixer configured to receive a heterogeneous material. The mixer may be in communication with the source of a fluid. The system may comprise a nozzle in communication with another nozzle.

The system may comprise a splitter. The splitter may split a fluid stream into at least two streams. Alternatively, the splitter may split into any number of even streams, for example, two streams, four streams, six streams, eight streams, etc. The splitter may be in communication with a nozzle.

The system may comprise a collision chamber array that may be configured to split a fluid stream in a plurality of fluid streams. The collision chamber array may be configured to direct the plurality of fluid streams into a plurality of individual collision chambers comprising nozzles.

The system may comprise a catch tank. The catch tank may be in communication with a pump and/or an intake of a pump. The pump may be a recirculation pump. The pump may be in communication with the splitter. The pump may be configured to discharge a fluid. The catch tank may be disposed across from the pump. The pump may be in communication with an inlet tank.

The system may comprise a modular nozzle. The modular nozzle may comprise an angled adapter, a motorized adapter, a position sensor, or a combination thereof. The modular nozzle may be configured to adjust the nozzle angle into a collision chamber. The angular adapter may be installed and/or exchanged. The angled adapter may change the angle and/or trajectory at which a fluid stream enters a collision chamber. The angled adapter may be disposed such that the angle of discharge below the horizontal may be about 5 degrees, about 5 degrees to about 20 degrees, about 8 degrees to about 16 degrees, about 10 degrees to about 14 degrees, or about 20 degrees. The angled and/or motorized adapter may be disposed on one or more sides of the collision chamber. Each side of the collision chamber may be configured to receive a modular nozzle. The motorized adapter may comprise a motor that moves the nozzle to change the angle and/or trajectory at which a fluid stream enters a collision chamber. The position sensor may be attached to the collision array and/or nozzle and may gather positional data from the fluid stream and/or nozzle to direct a motorized adapter to change the angle of the nozzle. The angle of the nozzle may be changed by an angular and/or motorized adapter to optimize the ablation of fluid comprising a heterogeneous material. The nozzle may be spaced and may comprise a spacer. The spacer may adjust the position of the nozzle. Other adjustment techniques may be used for different processing requirements.

The system may comprise a combined collision chamber which may comprise a plurality of modular nozzles. The plurality of modular nozzles may be configured to direct a plurality of fluid streams, each comprising a heterogeneous material. The plurality of modular nozzles may be at least partially disposed in parallel to each other. The plurality of modular nozzles may be at least partially disposed in a vertical plane allowing for an inter-collision region space in between the plurality of fluid streams. The inter-collision region may provide a secondary collision of heterogeneous material. The plurality of modular nozzles may be at least partially disposed in the combined collision chamber and may be at least partially parallel to each other in the horizontal plane.

The system may comprise an inter-collision separation device. The inter-collision separation device may be at least partially disposed into or removed from the inter-collision region space to separate and/or allow for the collisions of the plurality of modular nozzles. The collision chamber array may be at least partially disposed between a plurality of catch tanks such that a first portion of the heterogeneous material may be ablated and exits the collision chamber over a first catch tank. The first catch tank may be in communication with a pump, e.g., a recirculation pump. A second portion of the heterogeneous material may be ablated and exit over a second catch tank to be held for further processing by other methods. The collision chamber array may be at least partially disposed between the plurality of catch tanks such that the degree of dissociation of material and throughput of the system may be controlled.

The system may comprise a flow dividing chute. The flow dividing chute may be at least partially positioned at the meeting point of the crests of a plurality of tanks. The flow dividing chute may at least partially divide a fluid stream either equally or unequally between the plurality of tanks.

The system may comprise a reagent. The reagent may comprise a surfactant and/or collection reagents. The reagent may promote froth separation of one or more subfractions of dissociated heterogeneous material. The system may be used to accommodate the flow of the generated froth into a collection system. The generated froth may flow to a product refining system or be rejected from the system.

The system may comprise a conduit for a pressurized fluid. A nozzle assembly may be in communication with the conduit. The nozzle assembly may comprise a plurality of adjustable nozzles. The adjustable nozzles may be configured such that fluid streams passing through each of the plurality of adjustable nozzles intersect at an oblique angle. The oblique angle may be at least about 160 degrees, about 160 degrees to about 179.9 degrees, about 165 degrees to about 179 degrees, about 170 degrees to about 175 degrees, or about 179.9 degrees after passing through the plurality of adjustable nozzles.

The system may comprise monitoring and/or control equipment. The monitoring and/or control equipment may be in communication with any component of the system. The monitoring and/or control equipment may collect data and/or control any process and/or flow rate within the system.

The system may comprise a recovery tank. The system may be configured such that a plurality of modular nozzles and a plurality of recovery tanks are arranged in series. The series of recovery tanks may increase the number of particle collisions. The recovery tanks may each comprise a mechanical agitator that may maintain suspension.

The system may comprise a screen; a pump; a holding tank; and/or nozzle systems capable of being used in conjunction to process and sort particles by size throughout different points in the system; or a combination thereof. The pump may further comprise a pump impeller. The pump impeller may be oriented such that it evenly distributes the heterogeneous material into each fluid stream following through each of the fluid streams from the splitter.

The system may comprise a valve or other flow control device, wherein minor adjustments of the divided fluid streams may be made by means of the valve or the other flow control device. The valve or other flow control device may account for differences in flow characteristics of the intersecting fluid streams. Minor adjustments to the divided fluid streams may ensure proper impact of the fluid streams.

The system may further comprise a modular nozzle assembly wherein a plurality of modular nozzles are opposingly oriented over a recovery tank.

The system may comprise dissociating a subfraction of a heterogeneous material. A fluid stream comprising both a heterogeneous material and liquid transport medium, in communication with the discharge of a pump, may be split into multiple streams by a splitter. The pump may be a collision recirculation pump. The fluid stream may be split such that one or more streams are in communication with nozzles disposed in collision chambers operating in parallel. The discharge of the recirculation collision pump may be positioned such that the discharge stream of heterogeneous material and liquid may enter an open top catch tank. The discharge stream of heterogeneous material and liquid may exit over the top of a plurality of open top catch tanks.

The system may comprise a primary catch tank and a secondary catch tank. The primary catch tank may allow further ablation of ablated heterogeneous material, and the secondary catch tank may hold further ablated material for further processing by other methods.

The system may comprise a plurality of pumps to form fluid streams that converge to form a collision region with or without the use of a splitter. A stream exiting the discharge of one collision pump may be split into a plurality of fluid streams comprising heterogeneous material. The heterogenous material may be collided (ablated) with a plurality of jet streams comprising the same or different heterogeneous material. The jet streams may flow from an oppositely positioned pump or pumps. The jet stream may be split by a collision chamber array. The collision chamber array may be at least partially disposed between a plurality of catch tanks such that a portion of the heterogeneous material is ablated and exits the collision chamber over a first catch tank and another portion of the heterogeneous material is ablated and exits over a second catch. The collision chamber array may be at least partially disposed between the plurality of catch tanks such that the degree of dissociation of material and throughput of the system may be controlled.

The system may comprise surfactants and collection reagents to promote froth separation of one or more subfractions of the dissociated heterogeneous material. The system may generate froth and direct it into a collection system which may then flow to either further product refining or be rejected from the system.

The system may comprise a screen to separate the heterogeneous material into particles. The particles may be separated based on particle size, with the smaller particles separated out of the system as a product and the larger particles being processed by the fluid streams.

The system may comprise a catch tank comprising a cone bottom, flat bottom, or a combination thereof. The type of tank design may be further alternated in any order such that certain tanks in the series more selectively focus on transport of different varying particle sizes due to particle segregation resulting from tank design effects.

The system may comprise a transfer collision pump in fluid communication with a tank. Output from the transfer collision pump may or may not be in communication with either an individual chamber, collision chamber array, combined collision chamber, or combined collision chamber array.

The method for dissociating the heterogeneous material into subfractions may be controlled by altering the flowrate and slurry stream discharge characteristics of the transfer pumps between the tanks. The degree of dissociation may be regulated by altering the flowrate of a recirculation pump relative to the flowrate of the transfer pump. Use of this recirculation pump may not be necessary for certain applications. Regulating the degree of heterogeneous material dissociation may be achieved either manually or through the use of a control system.

The control system may vary the flowrate of the recirculation pump by use of a process monitoring instrument detecting properties of the heterogeneous material which may specify a higher or lower required recirculation pump flowrate or corresponding velocity of the heterogeneous material and liquid exiting the nozzle. The monitoring equipment may comprise an x-ray fluorescence scanning device or gamma radiation detector. The particle size may be monitored particle size slurry density or material or liquid or fluid flowrate of material entering a tank. The monitoring equipment may be in communication with the control system used to vary the flowrate.

Pressure or flowrate may be monitored, and data may be relayed to the control system. The control system may direct either the pump to increase flowrate or the control valves to adjust either completely open, completely closed, or in-between to constrict flow for adjustment of this flowrate.

The outlet of the collision chamber may allow for distribution of the fluid stream exiting the collision chamber to be equally or unequally divided between a system inlet tank in fluid communication with the intake of the collision recirculation pump and a catch tank in fluid communication with either the intake of a collision recirculation pump or in fluid communication with the intake of a process draw off pump.

The method may comprise use of a control system to increase or decrease the flow through a plurality of nozzles. The method may comprise use of a cyclone size separation device recirculating coarse or fine material back into the system.

The method may comprise dissociating the heterogeneous material into subfractions. The method may comprise pumping heterogeneous material; receiving the heterogeneous material into a mixer, wherein the mixer is in communication with a source of fluid comprising the heterogeneous material and a liquid transport medium; directing a fluid with a nozzle; discharging the fluid; splitting the fluid into a plurality of streams; and balancing the pressure of fluid streams exiting the nozzle by collision of the fluid streams, such that the flowrate through all streams is balanced at the same flowrate. The method may further comprise using a control valve and/or process monitoring equipment including, but not limited to, a transducer in communication with a control system, to adjust the pressure or flow rate of the fluid exiting splitters. The control valve may form at least a partial opening between a splitter and a nozzle.

The method may comprise processing a heterogeneous material, the method comprising: entraining heterogeneous particles of a material into at least one fluid stream; passing the at least one fluid stream through an adjustable nozzle; impacting the at least one fluid stream at an oblique angle in a range from about 160 degrees to about 179.9 degrees to ablate the heterogeneous particles of the material; and classifying the heterogeneous particles. Entraining the heterogeneous material into a fluid stream may comprise mixing the heterogeneous material with a fluid. The step of mixing the heterogeneous particles may comprise using a holding tank and a mechanical agitator to maintain particle suspension.

The method may comprise transporting the heterogeneous material into one or multiple mixing tanks to be mixed with water by means of a belt conveyer or other ore transportation device. The water may be removed from the heterogeneous particles by means of a dewatering filter, gravity-based separator, or other method, and the wastewater produced by this process is recycled back into the system. Wastewater may be held in a holding tank using controls to distribute the water to different processes throughout the system. Raw water may be added to the system as necessary to meet system requirements of the process due to the loss of small quantities of water from various processes in the system. Wastewater from the system may be recycled to be reused by the system.

The recovery tank may comprise a mechanical agitator that may maintain suspension. Any means of sedimentation suppression/mitigation may be used without limitation to agitation or recirculation pumping. Recirculation pumping may comprise use of a recirculation loop.

The system may comprise a screen, cyclone, pump, holding tanks, and nozzle configured to be used in conjunction to process and sort particles by size throughout different points in the system.

Each pump may comprise a pump impeller. The pump impeller may be oriented such that the pump impeller evenly distributes the heterogeneous material into each stream. The pump may be peristaltic pump and may comprise any other method of accelerating a fluid known in the art.

The nozzle assembly may comprise a plurality of adjustable nozzles opposingly oriented over, or in proximity to, a recovery tank.

Any fluid conduit and/or valve in the system may be configured to allow flow to be activated or deactivated between collision chambers while in operation.

Any fluid conduit and/or valve in the system may be configured to facilitate gravity flow between multiple recovery tanks, equalizing tank levels to account for fluctuations in flow rates between pumps.

Any part of the system or method may be operated as a batch or continuous system or method.

The heterogeneous material may comprise solid particles or a mixture of solid particles with a fluid. For example, the heterogeneous material may comprise an ore containing a metal to be recovered. The heterogeneous material may also comprise an oil-contaminated sand. The heterogeneous material may also comprise a fluid, wherein the fluid includes, but is not limited to, water; groundwater; processed water; culinary water; municipal water; distilled water; deionized water; sewage; an acid including, but not limited to, sulfuric acid, hydrochloric acid, nitric acid, or a combination thereof; a base including, but not limited to, sodium hydroxide, ammonia, or a combination thereof; an organic solvent including, but not limited to, pentane, hexane, heptane, or a combination thereof; a surfactant including, but not limited to, polyethylene glycol, polysorbate, polysorbate 80, polysorbate 20, sulfate, sodium dodecyl sulfate, cocamidopropyl betaine, decyl glucoside, alkyl polyglycoside, lauryl glucoside, sodium stearate, amine oxide, alkylbenzene sulfonate, or a combination thereof; a halide including, but not limited to, chloride ions, iodide ions, bromine ions, fluoride ions, or a combination thereof; a salt including, but not limited to, sodium chloride, calcium chloride, potassium chloride, or a combination thereof; an alcohol including, but not limited to, methanol, ethanol, isopropyl alcohol, or a combination thereof; any other aqueous solution; oil; mineral oil; or a combination thereof. The liquid may comprise dissolved compounds and/or atoms including, but not limited to, carbonate, oxygen, oxide, hydroxide, or a combination thereof. The fluid may comprise substantially pure water, or water removed from a water source (e.g., an underground aquifer) without purification and without added components. The fluid may be selected to balance economic, environmental, and processing concerns (e.g., mineral solubility or disposal). The fluid may be selected to comply with environmental regulations. The fluid may be substantially free of a reagent (e.g., a leachate, an acid, an alkali, cyanide, lead nitrate, etc.) that is formulated to chemically react with the particles in the heterogeneous material. The fluid may be contacted with the heterogeneous material at any point and/or step in the method. Optionally, the heterogeneous material may not comprise a fluid or be contacted with a fluid.

The system may comprise a hopper. The hopper may be configured to feed the heterogeneous material into a vessel. The hopper may be placed at a higher elevation than the vessel, such that the heterogeneous material flows by gravity into the vessel. The hopper may comprise a conveyor to move the heterogeneous material to the vessel including, but not limited to, an auger, tilt table, conveyor belt, or combination thereof, which may communicate with or be controlled by a computer including, but not limited to, a programmable logic controller (“PLC”), a computer processor, or a combination thereof. The computer may detect operating conditions of the system via one or more sensors (not shown) and may adjust the flow of the heterogeneous material.

The system may comprise a nozzle. At least a portion of the heterogeneous material may be directed through the nozzle to form a stream. The nozzle may comprise a conical region comprising a constant taper from the nozzle inlet to the nozzle outlet. The diameter of the nozzle may decrease at a constant rate from the inlet to the outlet. The nozzles may comprise a lip on the inlet to allow a flange to be pressed onto the nozzle for attachment to piping. The nozzle may comprise a ridge located on the body of the nozzle to center the nozzle in the collision chamber or nozzle spacer. The diameter of a nozzle may be at least about 0.25 inches, about 0.25 inches to about 3.0 inches, about 0.5 inches to about 2.5 inches, about 1.0 inches to about 2.0 inches, or about 3.0 inches.

The nozzle may be configured and/or disposed to direct the stream against an impact zone. The impact zone may be a region, a solid object, a solid surface, or a combination thereof. The system may also comprise a nozzle assembly, wherein the nozzle assembly comprises a body and a nozzle. The nozzle assembly may be a single unitary structure.

The stream may pass through one or more constriction zones separated by straight sections before exiting a nozzle. A nozzle assembly may comprise a plurality of channels, e.g., constriction zones. A plurality of constriction zones and straight sections may contribute to increased collimation and decreased wear of the nozzle assembly. Additional constriction zones may increase the efficiency of the system. The system may comprise a nozzle spacer. The nozzle spacer may adjust spacing between the nozzle and another nozzle and/or the spacing between the nozzle and the impact zone.

The nozzle spacers may be configured to simultaneously communicate with the collision chamber and the nozzle. The nozzle may protrude through an interior hole in the nozzle spacer. The chamber, nozzle, and spacer may be configured such that the chamber and nozzle may be used with or without the nozzle spacer.

Increasing the spacing between nozzles may increase the cross-sectional area of the jet stream just before entering the collision region. This may be referred to as “jet spreading.” Jet spreading may change the behavior of the particle collisions. The behavior of the collisions may change by increasing the tangential forces on particles, which may be advantageous in certain applications.

The impact zone may be centrally positioned proximate to the nozzles (e.g., between or among a plurality of nozzles, or on a surface across a gap from a single nozzle). In a system comprising two nozzles, the impact zone may be located approximately midway between the two nozzles (i.e., if the streams have equivalent mass flow and particle distribution) but may be located anywhere between the two nozzles or in any location in which the streams can intersect. The dimensions of the impact zone may be determined by design parameters including, but not limited to, the velocity of the mixed heterogeneous material; the size and/or shape of the nozzle; the roughness of the material of the nozzle assembly; the alignment of the nozzle; the number of nozzles; the distance between the nozzles; the length and/or number of the straight sections; the composition of the streams; or a combination thereof. The impact zone may encompass the point at which the diameter of each stream is at a minimum, and the velocity of each stream is at a maximum. The dimensions of the impact zone may correspond to the concentration of energy of the streams. In the collision of tightly focused streams, particles may be more likely to impact or collide directly with other particles traveling in an opposite direction than they are in streams intersecting in a larger volume. The particles have a greater probability of colliding directly if the streams themselves impact directly (e.g., one stream is positioned at an angle of about 180° relative to another, opposing stream) or nearly directly (e.g., one stream is positioned at an oblique angle relative to another, opposing stream). For example, one stream may be positioned between about 45° and about 180° (e.g., near 180°) relative to another, opposing stream. Likewise, in the collision of a tightly focused stream with a surface, particles may be more likely to collide with the surface perpendicularly than they are in a stream tangentially intersecting a larger area of the surface. Limiting or preventing flaring of the streams as the streams leave the nozzles may control the volume or area of the impact zone. Flaring may be reduced or eliminated by methods including, but not limited to, lengthening the straight section; precision machining; reducing surface roughness; applying a shielding fluid (e.g., air, water, oil, etc.) around the stream; or a combination thereof.

The kinetic energy of the streams may be used to separate heterogeneous materials of the particles in the streams, such as coatings or layers of the heterogeneous material overlying a core (e.g., a film, patina, varnish, oxide, or crust). For example, if the heterogeneous material (and therefore, each of the streams) comprises uranium ore and particles of sandstone, the kinetic energy of the streams may remove the light fines and/or the heavy fines from the grains. As another example, the kinetic energy may remove the silicate from the gold if the heterogeneous material comprises micro-fine gold particles having silicate patinas. As a further example, the kinetic energy may remove the oil coating from the grains of sand if the mixed heterogeneous material comprises oil-contaminated sand. Separation of heterogeneous materials may be a physical process (e.g., physical dissociation) and independent of any chemical process (e.g., chemical reaction, dissolution) of any heterogeneous materials. Heterogeneous materials may be separated with or without the addition of reagents (e.g., leachates, acids, alkalis, cyanide, lead nitrate, etc.), and the system and method may be used to recover materials that are conventionally recovered by environmentally or operationally problematic techniques. Chemical compounds may be present in the fluids such as water in trace amounts. The system and method of the present invention may be used to separate components of a heterogeneous material from one another even when none of the materials has sufficient solubility in the liquid for chemical separation. Reagents may be contacted with the heterogeneous material to enhance dissolution of a material of interest. For example, sodium bicarbonate may be added to the stream to promote the dissolution of uranium in conjunction with the energy input within the system.

The reagent may comprise a frother, collector, activator, depressant, pH modifier, or a combination thereof. The frother assists in the creation of a stable froth bed by inhibiting bubble coalescence and reducing surface tension and may include, but is not limited to, methyl isobutyl cabinol (“MIBC”), sodium lauryl sulfate (“SDS”), flottec F-171, pine oil, cresol acid, or a combination thereof. The collector may increase selectivity of flotation by increasing hydrophobicity of target mineral particles and may include, but is not limited to, potassium amyl xanthate (“PAX”), fuel oil, diesel, xanthate, dithiophosphate (“DTP”), or a combination thereof. The activator may assist collector adsorption onto target mineral particles, increasing recovery in concentrate and may include, but is not limited to, sodium silicate, copper sulphate, sodium hydrosulfide, sodium sulfide, or a combination thereof. The depressant may hinder collector adsorption onto gangue mineral particle surface, hindering recovery in concentrate and may include, but is not limited to, zinc sulfate, sodium dithiophosphate, lime, starch, or a combination thereof. The pH modifier may increase or decrease pH of slurry to increase flotation selectivity and may include, but is not limited to, lime, soda ash, sulfuric acid, sodium hydroxide, or a combination thereof. The dosing of the reagent may be at least about 1 gram per ton (“g/ton”), about 1 g/ton to about 1500 g/ton, about 10 g/ton to about 1250 g/ton, about 25 g/ton to about 1000 g/ton, about 50 g/ton to about 750 g/ton, about 100 g/ton to about 500 g/ton, or about 1500 g/ton.

Particles may be impacted with a lower energy, such as when a bond between two materials to be dissociated is relatively low. The impact energy may be lowered by adjusting one or more properties as described above. The impact energy may also be lowered by colliding the streams in a configuration other than directly opposing. Two or more streams may be aligned such that they intersect at an angle less than 180°, such as in the shape of the letter “V”. Such an arrangement may also direct the flow of the material after impact.

Nozzles may be disposed such that the axes of symmetry may intersect at an oblique angle. The streams passing through the nozzles may impact each other at an oblique angle (e.g., the axes of symmetry of the nozzles do not fall on the same line). The nozzle exits and the impact zone may not be collinear. For example, the streams may impact at an angle ranging from about 90° to less than about 180°. The angle to be near 180°, such that most of the kinetic energy of the streams is converted to impact energy. For example, the angle may range from at least about 160°, about 160° to about 179.9°, about 163° to about 179°, about 168° to about 176°, about 171° to about 173°, or about 179.9°. Impacting the streams at an oblique angle may result in relatively lower impact energy than a head-on impact. However, nozzles oriented directly head-on, or in a nozzle assembly having another configuration including an even number of nozzles, small perturbations in the flow of the streams may cause the flow through one or more of the nozzles to stop or clog the nozzles. This may not occur where nozzle assemblies comprise nozzles oriented obliquely to one another. Without being bound to any particular theory, where in which the streams impact each other directly head-on, a perturbation in the flow of the streams causes a shift in the location of the impact zone. The pressure in the impact zone may be higher than the pressure in the streams within the nozzles. A change in flow velocity or pressure of one stream relative to another stream, such that the streams are not balanced, may cause the impact zone to shift. The flow through that nozzle may stop if the impact zone shifts near one of the nozzles, because the pressure at the impact zone is greater than the pressure of the stream in the nozzle. When this occurs, flow through the system may be restarted by stopping and restarting the pump. However, a perturbation in the flow of one of the streams may cause movement of the impact zone but may not cause flow through any nozzle to stop when the streams impact at an oblique angle.

Wear on the exterior surface of the nozzle or on the interior of the straight section (e.g., the collimating tubes) may alter the nozzle geometry and change the efficiency of the ablation process. A non-brittle hard material may be disposed over and/or attached to at least one surface of the nozzle to protect the nozzle and straight section from wear. The non-brittle hard material may include, but is not limited to, a high-yield-strength metal resistant to abrasion (e.g., tungsten or hardened steel); a non-brittle ceramic; a diamond-impregnated ceramic; a hard-facing material; or a combination thereof. The non-brittle hard material may be a washer; a surface coating; a bonded plate; or a combination thereof. The non-brittle hard material may be attached to nozzles by an adhesive; a weld; fasteners (e.g., screws, nuts, bolts, nails, buckles, etc.), or by any other means or combination. For example, the non-brittle hard material may comprise a tungsten washer bonded to the nozzle with epoxy.

The system may comprise of plurality of nozzles in communication with a plurality of recovery vessel combinations. A first nozzle or plurality of nozzles may dispose heterogeneous material into an impact zone to be ablated. The ablated heterogeneous material may enter the first recovery vessel. Pumps may be used to transfer ablated heterogeneous material in the form of slurry from the first recovery vessel to a second nozzle. The slurry may be recycled to the first nozzle to achieve many particle collisions to form an ablation loop. Valves or other flow regulating devices may be used to make minor adjustments to the stream of heterogeneous material. The adjustments may be made to make up for differences in flow between the nozzles due to piping geometry, losses, or any other flow differences. This system may comprise a pump to continuously remove a specified amount of material from the ablation loop for further sorting and processing.

The system may operate at a pressure of at least about 10 pounds per square inch (“psi”), about 10 psi to about 120 psi, about 20 psi to about 100 psi, about 30 psi to about 90 psi, about 40 psi to about 80 psi, about 50 psi to about 70 psi, about 120 psi. The flow rate through a nozzle may be at least about 5 gallons per minute (“gpm”), about 5 gpm to about 1300 gpm, about 10 gpm to about 1200 gpm, about 25 gpm to about 1100 gpm, about 50 gpm to about 1000 gpm, about 100 gpm to about 900 gpm, about 200 gpm to about 800 gpm, about 300 gpm to about 800 gpm, about 400 gpm to about 700 gpm, about 500 gpm to about 600 gpm, or about 1300 gpm. The total volume of flow increases with increasing numbers of nozzles.

The system may comprise a splitter system comprising an impeller pump, stream splitter, and collision chamber. The orientation of the pump impeller may evenly distribute the heterogeneous material into each stream flowing through each of the streams from the splitter. The adjustments of the divided fluid stream may be made via a valve or other flow control device to account for differences in flow characteristics of the intersecting fluid streams. The adjustment may ensure optimal impact of the fluid streams.

The collision chamber may comprise nozzles mounted onto a plate. The plate may be attached to the collision chamber in any way including, but not limited to, by threaded fasteners, grooved coupling, compression devices, or a combination thereof. The plate may be configured to position the nozzle at an angle in the collision chamber. The angle of the nozzle may affect the angle at which a heterogeneous material stream enters the collision chamber. The plate may be interchanged with another collision chamber without modification to the plate. The plate may position the nozzle at any angle within a 180-degree arc.

The system and method may be used to process heterogeneous material having a concentration of mineral components too low for economic recovery by conventional processes. For example, waste or overburden from other processing operations may be processed using ablation. A heterogeneous material may be treated by ablation to aid in environmental remediation, such as by lowering the concentration of chemical species in material previously mined. For example, the system and method may be used for remediation of contaminated land near mines no longer operating. In such embodiments, the goal may be clean-up of a site. The material of interest recovered may be disposed of, sold, or further processed. The amount of the material of interest being disposed of may be less than the total amount of the heterogeneous material initially contaminated.

Transfer of the heterogeneous material, slurry, and/or water within the system may be performed by centrifugal pump, peristaltic pump, diaphragm pump, other pump or transportation device, or a combination thereof. The elements of the system such as piping, valves, connections, control systems, monitoring devices, wiring, and all other hardware may be varied by individual components, as known by a person skilled in the art.

The heterogeneous material may comprise carbonaceous matter. Carbonaceous matter may be contacted with the heterogeneous material. Any suitable carbonaceous matter may be contacted with the heterogeneous material. For example, suitable carbonaceous matter may be insoluble, fully soluble, or partially soluble. The carbonaceous matter may be agglomerated with the heterogeneous material, such that particles or chunks may not exist as discrete particles or chunks but would, for example, be agglomerated together into a mass. The carbonaceous matter may comprise carbon black; carbon black particles; activated carbon; graphite; carbon anode scrap; charcoal; coal; solid organic carbon; carbon naturally present in the heterogeneous material; or a combination thereof. The dosage and particle size of the carbonaceous matter can be any suitable dosage and particle size.

The heterogeneous material may comprise a surfactant. The surfactant may be contacted with the heterogeneous material. The surfactant may include, but is not limited to, an anionic surfactant, cationic surfactant, zwitterionic surfactant, nonionic surfactant, or a combination thereof. The surfactant may cause at least a portion of the heterogeneous material to become hydrophobic and be separated from the remaining heterogeneous material by flotation.

The system may comprise an analytical instrument. The analytic instrument may include, but is not limited to, an X-ray emitter and/or detection; X-ray fluorometer; X-ray chromatograph; fluorometer; gamma radiation emitter and/or detector; turbidity meter; pH meter; ion meter; laser particle analyzer; colorimeter; pressure meter; voltage meter; nuclear magnetic resonance spectrometer; high-performance liquid chromatograph; gas chromatograph; mass spectrometer; inductively coupled mass spectrometer; oximeter; or a combination thereof. The analytical instruments may be controlled by the computer including, but not limited to, a PLC, processor, or a combination thereof. The computer may use data from the analytical instruments to calculate a mass balance in real time. The computed mass balance may be used in the control mechanism of the system including, but not limited to, quality control, maintenance, accounting, or combination thereof. For example, the computer may track the amount of material processed in the system or the amount of a selected material produced.

The method may comprise applying an analytical instrument, measurement, or method to the system and/or heterogeneous material. The analytic instrument may measure gamma radiation; X-ray radiation; other radiation; gas content, emission, and/or composition; fluid content, emission, and/or composition; solids content and/or composition; ion concentration including, but not limited to, carbonate, bicarbonate, oxide, or hydroxide concentrations, or a combination thereof; particle size and/or particle size distribution; pH; or a combination thereof. A radiation measurement may be used to determine the concentrations of isotopes of a heterogeneous material and/or material of interest.

Heterogeneous material may be processed with the system and according to the method described herein. Heterogeneous material may be crushed and/or screened to remove particles larger than a selected size, such as particles that are too large to be effectively processed in the system. For example, particles larger than about 0.25 inches (larger than about 6.35 millimeters) may be removed. A heterogeneous material may comprise at least about 5%, about 5% to about 35%, about 10% to about 30%, about 15% to about 25%, or about 35% or more of particles larger than about 0.25 inches (larger than about 6.35 millimeters) upon crushing. Heterogeneous material particles larger than about 0.25 inches that have been mechanically crushed may not contain a material of interest. Therefore, these particles need not be processed and may instead be discarded as barren waste and/or used to reclaim mines.

Optionally, the method may not comprise a screening and/or crushing step. Heterogeneous material comprising solid feedstock may be within size requirements of the system before entering the system. For example, oil-contaminated sand or silicate-coated gold may not require screening and/or crushing because the grains of these heterogeneous materials may all be within, or be substantially within, a range of sizes that may pass through the system.

The method may comprise contacting the heterogeneous material with a fluid to form a slurry. The slurry may be formed in a tank. The heterogeneous material may be contacted with the fluid before adding the heterogeneous material to the system. For example, the heterogeneous material may be an ore from an underground formation and the ore may be extracted by borehole mining. In borehole mining, the ore may be extracted from the formation by a high-pressure water jet, and may be carried to the earth's surface by the fluid. The contacting of the heterogeneous material (e.g., ore) with the fluid (e.g., water) occurs in the underground formation. The slurry may comprise any ratio of solids-to-liquids as long as the system is capable of flowing the slurry to an impact zone. The slurry may comprise from at least about 5%, about 5% to about 65%, about 10% to about 60%, about 15% to about 55%, about 20% to about 50%, about 25% to about 45%, about 30% to about 40%, or about 65% solids by mass.

The slurry that has been processed through the nozzle may be processed to separate particles by size. For example, the slurry may be passed through a size sorting apparatus to separate particles larger than the mesh size of the screen from particles smaller than the mesh size of the screen. For example, the particles of the slurry may be separated into grains larger than at least about 0.004 inches (0.10 millimeters) and fines smaller than at least about 0.004 inches (0.10 millimeters) by appropriately selecting the mesh size of the screen. A plurality of separations may be performed, such as by passing at least a portion of the slurry through a plurality of screens in series. Different size classifications may be selected by selecting one or more appropriate size sorting apparatuses.

The method may comprise removing water from the slurry by a dewatering method including, but not limited to, a dewatering filter, gravity-based separator, or a combination thereof. The waste fluid produced by this process may be recycled back into the system. The waste fluid may be held in a holding vessel in communication with controls, e.g., pumps, conduits, etc., to distribute the water to different processes throughout the system. Fluid may be added to the system as necessary to meet system requirements of the process due to the loss of small quantities of fluid from processes in the system.

The system may comprise a recovery vessel comprising mechanical agitators to maintain suspension of a heterogeneous material. The system may also comprise a holding vessel and a mechanical agitator to maintain heterogeneous material particle suspension.

The system and method may separate particles with different compositions having approximately the same size where separation by size classification may be difficult or expensive. The system may comprise a plurality of screens, pumps, holding vessels, and nozzle systems, or a combination thereof to process and sort particles by size throughout different points in the system. The method may comprise separating particles based on particle size, with the smaller particles separated out of the system as a product and the larger particles being processed by a fluid stream.

For example, metal-rich fines may have similar sizes as non-bearing or metal-depleted fines formed from ablation of heterogeneous material from a single formation. The fines may be light or heavy fines. Light and heavy fines may require different techniques to recover a metal. The fines may be gravimetrically separated to reduce the amount of heterogeneous material that must be processed by other means (e.g., chemically) to extract the metal. The fines may be at least partially disposed in a vertical column of a first fluid. A second fluid may flow upward through the column so as to generate a turbulent flow rate. The fluid may include, but is not limited to, water, mineral oil, an organic solvent, air, a noble gas, or a combination thereof. The first fluid may be selected based on its flow properties, availability, and minimal environmental impact. The fines may be separated in the column by their densities, with heavier fines dropping to the bottom, and lighter fines rising to the top. Gravimetric separation may be performed in one or more stages, with different stages having different densities at which the separation occurs. Gravimetric separation parameters may affect the separation including, but not limited to, the type of fluid used; the temperature of the separation; the flow rate of the separation; the length and diameter of the column; or a combination thereof.

The system may be configured to ablate and sort heterogeneous material by particle size. The system may comprise a mixing vessel comprising a mechanical agitator. The mechanical agitator may mix anhydrous and/or dry heterogeneous material with a fluid. The mixing vessel may be fed by a transport conduit including, but not limited to, a conveyer, auger, or another ore transportation system. The system may comprise a screen that sorts heterogeneous material particles based on size, with undersized particles being separated out before an ablation loop. Larger particles may be transferred into a particle holding vessel and may then be transferred to the first recovery vessel.

The system may comprise a plurality of monitoring and control equipment in communication with any element of the system. The monitoring and control equipment may collect data and control the processes and flow rates within the system.

The heterogeneous material removed from the ablation loop may be processed through a size sorting apparatus including, but not limited to, a screen, filter, sieve, mesh membrane, or a combination thereof. The sorting apparatus may sort oversized particles, to be transported to particle holding vessel. The particle holding vessel may comprise a pump to transport the oversized particles into a dewatering filter or other dewatering system. The solids from this filter may be removed and/or rejected. The water from this dewatering system may be recycled into a recycled water vessel. The undersized particles removed from the screen after the ablation loop may be further processed using a clarifier or other percent solids concentration system.

The method may comprise borehole mining. The borehole mine may provide the heterogeneous material to be processed by the system and according to the method of the present invention. The use of borehole mining in conjunction with the system may provide operational, environmental, and other advantages. For example, borehole mining may be used to extract minerals from unbounded deposits, deposits located above the water table, shallow deposits with insufficient hydrologic permeability, deposits in impermeable rock formations, or small deposits of minerals that may not be economically, technically, or lawfully recoverable by conventional methods. Borehole mining may be performed in independent wells that may or may not be connected to other wells in a mining field. A single well may be used to penetrate a formation, scour heterogeneous material from the formation to form a slurry, carry the scoured heterogeneous material to the surface, and return barren fractions of processed heterogeneous material to the formation. Borehole mining may allow extraction of minerals with a reduced surface footprint in comparison to conventional methods.

Borehole mining is a technique for extracting mineral deposits from an underground formation. A borehole may be drilled to a given depth. A casing may be inserted into a portion of the borehole. A borehole mining tool may be inserted into the borehole, and water may be pumped into the tool to produce a high-pressure water jet. The water jet may scour ore or other raw material from the formation to form a raw slurry, and the mined ore or raw material may be carried to the surface.

Borehole mining may enable the removal of heterogeneous material without removing the heterogeneous material by injecting a leachate or lixiviant into a formation. In borehole mining, water jets may physically remove heterogeneous material without chemically mobilizing or dissolving metals, limiting the risk of aquifer contamination. A water jet may operate without modifying formation chemistry and without additional reagent costs. Borehole mining may begin with less information known about the formation because the heterogeneous material of the formation is extracted, rather than processed in-situ. Geochemical classification and permeability of the formation may not be necessary to perform a borehole mining operation because borehole mining may not rely on chemical reaction or on permeation.

Borehole mining may be used to scour heterogeneous material from a volume of an underground formation. The volume may be wedge-shaped. The extent of the volume may be tailored by controlling the direction, location, and intensity of the water jets. Borehole mining may be used to asymmetrically scour the formation, roughly following formation boundaries. The heterogeneous material from the volume may be extracted and processed. The volume may then be refilled, such as with barren waste or fill and, optionally, a cementing material. Additional volumes may be excavated by a water jet and may be excavated from a well from which heterogeneous material have previously been excavated and/or refilled. The refilled volumes may provide structural support for volumes excavated after an initial excavation. Reinjection of the barren waste may reduce surface disturbance and reclamation requirements. The system may comprise a surge tank to regulate the flow of heterogeneous material to the system when used in conjunction with borehole mining.

The system and method may also be used to process feedstocks from other types of mining operations, such as open-pit mining or underground mining. In such operations, heterogeneous material may be mined conventionally and processed by ablation, for example, near the mine. The barren waste may be returned to the mine, leaving a small bearing fraction. The bearing fraction may be transported elsewhere for further processing. Transportation costs may be reduced compared to conventional mining by separating the heterogeneous material according the system and method near the mine.

Fluid used in the apparatus and method may undergo a dewatering process. Fluid may be processed, added, or removed by filtration, nanofiltration, ion exchange, countercurrent ion exchange, forward osmosis, reverse osmosis, electrodialysis, evaporation, or a combination thereof. The dewatering process may reduce or increase fluid concentration and/or remove an impurity and/or a residual from the fluid. The dewatering process may enable recycling of the fluid.

The system may comprise a dewatering system. The dewatering system may comprise one or more elements for concentration and/or dewatering a solution and/or slurry comprising the heterogeneous material or the material of interest. The dewatering system may comprise a pre-ablation loop screen; a post-ablation loop screen; a gravity-based separator (e.g., a clarifier); a dewatering filter; a recycling vessel that may receive recycled water and/or recycled solution produced from the dewatering system, or a combination thereof. The method may comprise recycling fluid from any process within the system.

The recycled water and/or recycled solution disposed in the recycling vessel may be flowed to supply water to any of the elements which require water and/or solution in the system. These elements may include, but are not limited to, a mixing vessel for dry heterogeneous material; a screen; an ablation loop; a slurry holding vessel; or a combination thereof. The recycling vessel may be replenished by flowing water and/or solution into the recycling vessel.

The method may be a batch process such that a discrete amount of heterogeneous material is processed. The method may be a continuous process such that a continuous stream of heterogeneous material flows through the system.

The method may be used to liberate a first heterogeneous material component from a second heterogeneous material component. The first or second component may comprise the material of interest.

There may be a plurality of systems. The plurality of systems may operate in parallel. Operating the plurality of systems in parallel may ablate more than one heterogeneous material than a single system to produce more than one material of interest. The plurality of systems may operate in series. Operating the plurality of systems in series may improve the refinement and/or concentration of the material of interest compared to operating a single system. The system and method may be configured to be used in combination with another system to achieve operation in series. For example, a heterogeneous material (e.g., ore from a mining operation) may be processed in a first ablation system. After ablation in the first system, ablated heterogeneous material may be processed in a second system for further ablation. The ablated heterogeneous material leaving the first system may be tested to determine whether subsequent processing is necessary or desirable. The material may be processed through as many systems as necessary to achieve desired material properties. The flow of material through a system may be varied during operations. For example, during a mining operation, heterogeneous material properties may vary widely within a formation. Some materials may be profitably processed through a single ablation system, whereas other materials may be profitably processed through two or more systems in series. The flow of materials through a plurality of systems may be varied during mining operations in response to changes in materials to be processed.

The heterogenous material may comprise a contaminant, wherein the contaminant may comprise Uranium, Radium-226, or other contaminant. The contaminant may be disposed on the heterogeneous material in the form of a coating. The contaminant may comprise a Moh's hardness value distinct from the Moh's hardness value of the heterogeneous material. For example, the Moh's hardness value of the contaminant may be lower than the Moh's hardness value of the heterogeneous material.

The kinetic energy of the streams may be used to separate heterogenous materials of the particles of the stream, such as coatings or layers of contaminant disposed on the heterogenous material. For example, if the heterogenous material (and therefore, each of the streams) comprises contaminant coating and particles of heterogenous material, the kinetic energy of the streams may break off the contaminant coating from the heterogenous material through a grain-boundary fracture, inter-granular fracture, or phase boundary fracture.

The method may comprise steps of screening the heterogeneous material to remove particles of selected size from the heterogenous material using a screen. The screen may comprise a mesh of at least about 635 mesh, about 635 mesh to about 400 mesh, about 400 mesh to about 25 mesh, about 25 mesh to about 4 mesh, about 4 mesh to about ¼ in. mesh, or about ¼ in. mesh. For example, the larger particles remaining after the screening steps may be introduced into the ablation portion of the system to increase efficiency and throughput due to higher kinetic energy of larger particles when undergoing collisions. Alternatively, the screening steps may comprise the isolation of larger particles prior to introduction into the ablation portion of the system to be discarded as barren waste and/or used to reclaim mine.

The method may comprise a crushing step wherein the larger particles are crushed to form smaller particles prior to introduction into the ablation portion of the system.

The system and method may separate particles by size. The system may comprise a plurality of screens, hydrocyclones, pumps, crushers, holding vessels, and nozzle systems, or a combination thereof to process and sort particles by size throughout different points in the system. The method may comprise separating particles based on particle size, with the smaller particles separated out of the system and the larger particles being processed by a fluid stream.

Embodiments of the present invention provide a technology-based solution that overcomes existing problems with the current state of the art in a technical way to satisfy an existing problem for operators generating product waste from heterogeneous material. Embodiments of the present invention achieve important benefits over the current state of the art, such as reduced waste, increased production time, and faster refinement times. Some of the unconventional steps of embodiments of the present invention include improved ablation and re-ablation of heterogeneous materials.

Note that in the specification and claims, “about” or “approximately” means within twenty percent (20%) of the numerical amount cited. The terms, “a”, “an”, “the”, and “said” mean “one or more” unless context explicitly dictates otherwise. The term “and/or” as used herein means that the listed items are present, or used, individually or in combination. In effect, this term means that “at least one of” or “one or more” of the listed items is present or used.

Terms of degree such as “substantially”, “about” and “approximately” as used herein mean a reasonable amount of deviation of the modified term such that the end result is not significantly changed. These terms of degree should be construed as including a deviation of at least ±20% of the modified term if this deviation would not negate the meaning of the term it modifies.

Although the invention has been described in detail with particular reference to these embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A system for processing a heterogenous material, the system comprising:
a vessel in communication with a primary screen;
a first collision chamber in communication with said vessel;
a first recovery vessel;
a second collision chamber in communication with said first collision chamber;
a second recovery vessel; and
a secondary screen.

2. The system of claim 1 further comprising a clarifier in communication with said primary screen.

3. The system of claim 1 further comprising a clarifier in communication with said secondary screen.

4. The system of claim 1 further comprising a mixing vessel in communication with said primary screen.

5. The system of claim 1 wherein at least one of said collision chambers comprises a nozzle.

6. The system of claim 5 wherein at least one of said collision chambers comprises a nozzle spacer system.

7. The system of claim 1 wherein at least one of said collision chambers comprises a plurality of nozzles disposed at oblique angles to one another.

8. The system of claim 1 further comprising a dewatering filter.

9. The system of claim 1 wherein at least one of said collision chambers comprises a collision array.

10. A method for processing a heterogenous material, the method comprising:
disposing the heterogenous material in a vessel;
clarifying the heterogenous material in a clarifier;
ablating the heterogenous material in a first collision chamber to form ablated heterogenous material;
disposing the ablated heterogenous material in a first recovery vessel;
further ablating the ablated heterogenous material from the first recovery vessel to a second collision chamber; and
flowing the further ablated heterogenous material in a second recovery vessel.

11. The method of claim 10 further comprising mixing the heterogenous material.

12. The method of claim 10 further comprising screening the heterogenous material.

13. The method of claim 10 further comprising splitting the heterogenous material with a splitter.

14. The method of claim 10 further comprising ablating the heterogenous material with a collision array.

15. The method of claim 10 further comprising ablating the heterogenous material with a combined chamber array.

16. The method of claim 10 further comprising separating the ablated heterogenous material with a flow dividing chute.

17. The method of claim 10 further comprising screening the ablated heterogenous material.

18. The method of claim 10 further comprising contacting the ablated heterogenous material with a reagent.

19. The method of claim 18 wherein the reagent comprises a frother.

20. The method of claim 10 further comprising collecting the ablated heterogenous material in a collection tank.
